(19) United States
(12) Patent Application Publication
(10) Pub. No.: US 2013/0185198 A1
(43) Pub. Date: Jul. 18, 2013

(54) Incremental Content Purchase And Management Systems And Methods

(71) Applicant: Yoav Lorch, Herzliah (IL)

(72) Inventor: Yoav Lorch, Herzliah (IL)

(21) Appl. No.: 13/745,689

(22) Filed: Jan. 18, 2013

Related U.S. Application Data
(60) Provisional application No. 61/587,672, filed on Jan. 18, 2012.

(51) Int. Cl. G06Q 20/22

(52) U.S. Cl. CPC G06Q 20/29
USPC 705/39

(57) ABSTRACT

Systems and methods for incremental and conditional purchase and management of electronic books. In one embodiment, the incremental content purchase and management system allows downloading of electronic books to client devices with no upfront cost. Electronic books downloaded on a client device are divided into a plurality of segments based on the mode of consumption. User interaction with an electronic book is monitored to detect consumption, and to identify the segment being consumed. When a sufficient amount of electronic book segments is consumed, a charge corresponding the consumed electronic book segments is calculated using a charge model. The ownership of the consumed electronic book segments is then transferred to the user following the payment of the calculated charge.

### CROSS-REFERENCE TO RELATED APPLICATIONS

This application claims priority to and benefit from U.S. Provisional Application No. 61/587,672, titled “Incremental Content Distribution” filed on Jan. 18, 2012, the content of which is herein expressly incorporated by reference in its entirety.

### BACKGROUND

Electronic books (“e-books”) are consumed using dedicated e-readers such as Kindle, or general purpose portable or mobile devices such as the iPad, iPhone, Samsung Galaxy Tab, and the like. A consumer generally purchases a desired e-book online using a dedicated e-reader (e.g., Kindle, Nook), a general purpose e-reader (e.g., tablets such as Samsung Galaxy Tab, iPad, smart phones, etc.), or other computing devices. The cost of the e-book is paid up front. If the consumer is not happy with the purchase, some e-book distributors and/or publishers may allow the consumer to request a refund. However, the request for refund must usually be initiated by the consumer, and be made within a few days or hours after the purchase.

Some e-book distributors and/or publishers offer free samples to provide consumers a glimpse of the e-book. However, the free samples only push the purchase decision to a later point of time. If a consumer desires to consume beyond what is offered for free, the consumer must purchase the whole e-book by paying the retail or sale price.

### BRIEF DESCRIPTION OF THE DRAWINGS

FIG. 1 is a diagram illustrating an example environment in which the incremental content purchase and management (“ICPM”) system may be implemented.

FIG. 2 is a block diagram illustrating components of the ICPM system implemented on a client device.

FIG. 3 is a block diagram illustrating components of the ICPM system implemented on a server.

FIG. 4 is a diagram illustrating customized segmentation of e-books into a plurality of portions in one embodiment of the ICPM system.

FIG. 5 is a logic flow diagram illustrating an exemplary method e-book intake management in one embodiment of the ICPM system.

FIG. 6 is a logic flow diagram illustrating an exemplary method of downloading of an e-book in one embodiment of the ICPM system.

FIG. 7 is a logic flow diagram illustrating an exemplary method of monitoring e- book consumption in one embodiment of the ICPM system.

FIG. 8 is a logic flow diagram illustrating an exemplary method of charging for e- book consumption in one embodiment of the ICPM system.

FIG. 9 is a logic flow diagram illustrating an exemplary method of gifting an e-book in one embodiment of the ICPM system.

FIG. 10 is a logic flow diagram illustrating an exemplary method of updating charging parameters in one embodiment of the ICPM system.

FIG. 11 is a logic flow diagram illustrating an exemplary method of generating recommendations in one embodiment of the ICPM system.

FIGS. 12A-B are exemplary user interface diagrams illustrating e-book shelves in one embodiment of the ICPM system.

FIG. 13 is an exemplary user interface diagram illustrating e-book shelf management in one embodiment of the ICPM system.

FIG. 14 is an exemplary user interface diagram illustrating user activity time line in one embodiment of the ICPM system.

FIG. 15 is an exemplary user interface diagram illustrating account management in one embodiment of the ICPM system.

FIG. 16 is an exemplary user interface diagram illustrating a personal store in one embodiment of the ICPM system.

FIG. 17 is an exemplary user interface diagram illustrating an e-book viewer in one embodiment of the ICPM system.

FIG. 18 is an exemplary user interface diagram illustrating an analytics dashboard in one embodiment of the ICPM system.

FIGS. 19-20 are exemplary analytics results that can be generated from the analytics dashboard of FIG. 18.

FIG. 21 is a diagram illustrating a representation of a machine in the example form of a computer system.

### DETAILED DESCRIPTION

The incremental content purchase and management (hereinafter “ICPM”) systems and methods described herein provide a new mode of paying for electronic books based on e-book consumption. The term electronic book or e-book as used throughout the application encompasses all forms of digital content including e-books, audio books, articles, magazines, audio files, video files, documents, web pages, mobile application content, other digital publications and the like.

Users of the ICPM system do not buy an e-book upfront. Instead, the users download any desired e-books from an e-book store to their e-book readers or other client devices on which an ICPM client application is installed. In one embodiment, the downloaded e-books are available for access online or offline. In a further embodiment, the downloaded e-books can be shared between users of the ICPM system. When a user starts reading the e-book, the ICPM system monitors the reading activity and at certain points, creates charges to an account associated with the user and/or the client device. In one embodiment, each charge that is created may correspond to the amount of the e-book content read, the amount of time spent the e-book, the specific portions of the e-book content read, the geographical location of the reading, the date and/or time of reading, the rate or speed of reading, and the like. The user is not charged for any unread portions of the e-book.

The ICPM system breaks a full, organic, coherent content item such as an e-book into many small pieces, and charges a price for each piece as it is consumed by a user. The small pieces, on their own, have little or no value or relevance, unlike a music album or an episodic television program. For example, a music album can be broken into individual songs, where each song is a coherent and full piece of work that has a value on its own. Similarly, an episodic television program can be divided into episodes, where each episode has a value and is designed to be consumed episode by episode. A user must purchase a whole song or whole episode, regardless of whether or not the user listens to the song or watches the episode. Similarly, a pay-per-view video consumer also pays for the video upfront, regardless of whether or not the user watches a part of the video or the full video.

A purchase via the ICPM system can be a conditional incremental purchase, with the purchase being spread over time, and divided into a multitude of small purchasing events. Via the incremental purchase, ownership grows gradually, and the growth of ownership, or the ‘purchase events’ are instigated by usage of the product, or other events. The consumption of the product, and its gradual ownership may or may not be linear, or reflect a pre-planned consumption mode. For example, in the case of an e-book, the reader can start reading the book from the end, skip pages, go back to a previous page, etc. During the course of consuming an e-book via the ICPM system, the user goes from owning a portion of the e-book that he or she has read to owning the whole e-book, in the same way he or she would have owned the e-book had the e-book been bought upfront. The ownership of any e-book is thus an incrementally evolving ownership, with the exact level of ownership of any e-book determined at a point in time.

Various implementations of the ICPM system and method will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

Example Environment And Architecture

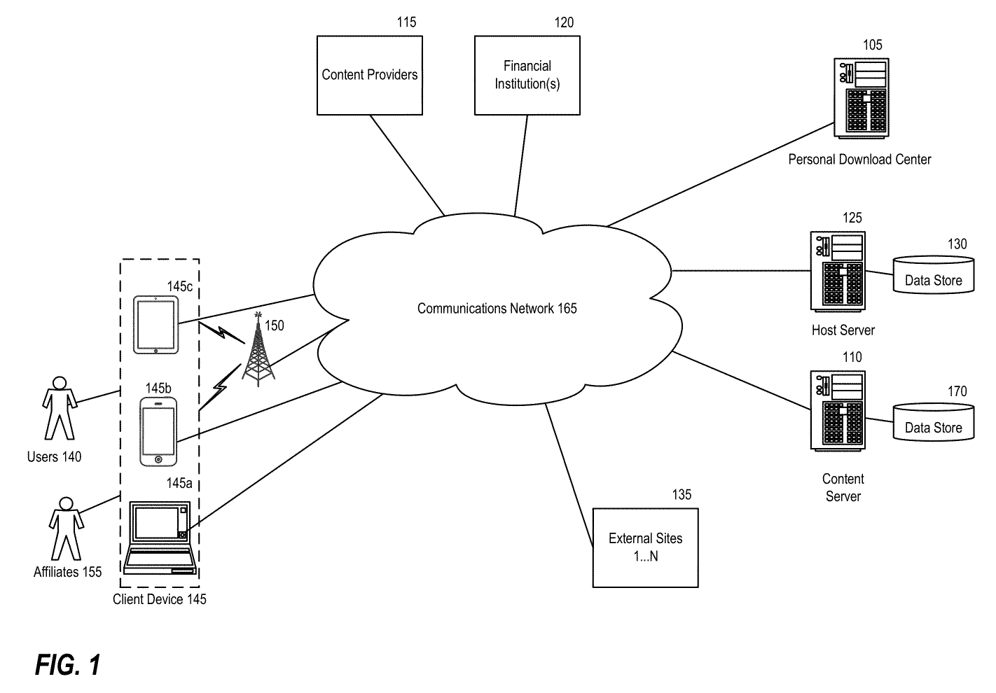

The ICPM system may be implemented in a suitable computing environment 100 shown in FIG. 1. Although not required, aspects and implementations of the ICPM system will be described in the general context of computer executable instructions, such as routines executed by a general purpose computer, a personal computer, a server, or other computing systems.

The ICPM system operates in environment 100 including users 140 and affiliates 155, that can use a plurality of client devices 145 connected to a communication network 165 to access the facilities and services hosted, supported and/or provided by remote servers such as the host server 125, the content server 110 and the personal download center 105.

Any of the client devices 145 such as, but not limited to, a computer (not shown), a laptop 145a, a mobile phone 145b, tablet 145c, an e-book reader, and the like, can be used by a user 140 to access an ICPM client application installed on the client device 145. Users 140 include e-book readers who are registered users of the ICPM system. Affiliate users 155 can include ICPM users, external users or other entities. Affiliate users 155 provide e-book recommendations to ICPM users, create and/or promote e-book shelves or book voyages comprising a collection of e-books having any desired theme, genre or subject matter on the ICPM system.

The client ICPM application installed on or accessed via the client device 145 communicates with the ICPM system hosted on the host server 125 over network 165. Network 165 may include wired and wireless networks, private networks and public networks (e.g., the Internet). Client devices 145 may use their network interfaces to connect to and/or communicate with network 165, either directly, or via wireless routers, or cell towers 150. Network interfaces may employ connection protocols such as direct connect, Ethernet, wireless connection such as IEEE 802.11a-n, and the like to connect to network 165. The host server 125 is also connected to network 165 to provide ICPM services.

In one embodiment, host server 125 may be a web server, hosting a website that provides users 140 access to the facilities of the ICPM system. In a further embodiment, host server 125 may also host a web portal accessible to content providers 115. Host server 125 may access and/or store all the information relevant to running the system from one or more databases and/or database tables such as the data store 130.

Content providers 115 may include, for example, publishers (e.g., agency, wholesale, direct publishers), authors, owners and/or generators of content such as e-book content which usually comprises text and/or images, but may also comprise links, animation, audio, video, and/or the like. Content providers 115, in one embodiment, may access the facilities of the ICPM server 130 via a web-site or portal. Alternately, or in addition to the website or portal, content providers 115 may also access the facilities of the ICPM server 125 via a content provider client application.

Content server 110 operating in environment 100 may be responsible for checking, managing, storing and providing for download to users and others digital content or publication such as e-books, audio books, magazines, audio files, video files, documents, and the like in various formats. Content server 110 may connect to host server 125 and content providers 115 via network 160. Content server 110 may store e-book and other content received from content providers in one or more database tables such as data store 170. Content providers 115 may upload content in various formats to content server 110 in one implementation. Alternately, content providers 115 may upload content to host server 125. In one embodiment, the content server and the host server may be one and the same.

A personal download center 105 operating in environment 100 is an online store personalized for a specific user. Personal download center 105 may be implemented on content server 110, host server 125 and/or a separate server. The personal download center 105 may be implemented as a web-based store or an application store accessible via the ICPM client application. The personal download center 105 is not an ordinary store where an item (that is not free) must be purchased prior to the download. Users of the ICPM system can visit the personal download center 105 to download e-books and other content items to their client devices for incremental purchase triggered by consumption or usage. In one embodiment, the personal download center 105 may be personalized with recommendations for e-books, curated shelves of e-books, and/or the like.

Environment 100 may also include one or more external sites 135 such as the Facebook, LinkedIn, Google+, Twitter, and/or the like to which user activities can be fed. For example, users 140 can post messages, report on on-application activities, share download/view links to e-books, e-book shelves, and/or the like on the external sites 135. The external site users who click on the posted links, and who do have the client application installed on their client device, may be directed to a download center (e.g., Apple app store or the Google Play) to download the ICPM client application. Alternately, when the posted links are clicked on by users who have a client application installed on their client devices, the client application may be launched in order to display the content embedded in the link.

One or more financial institutions 120 may also operate in the environment 100. Financial institutions 120 may include banks and/or other institutions with which the users have financial accounts (e.g., credit card account, debit card account, savings account, money market account, prepaid card account, and/or the like). The host server 125 may communicate with the financial institutions 120 to bill users, add funds to users' accounts in the ICPM system, deposit payments to authors, publishers, affiliates, and/or other parties operating in environment 100.

The term “server” as used herein refers generally to a computer, device, program or combination thereof that processes and responds to requests from remote clients across a network. The term “client” as used herein refers generally to a computer, device, program or combination thereof that is capable of processing and making requests, obtaining and processing responses from servers via a network.

Example ICPM System On Client Device

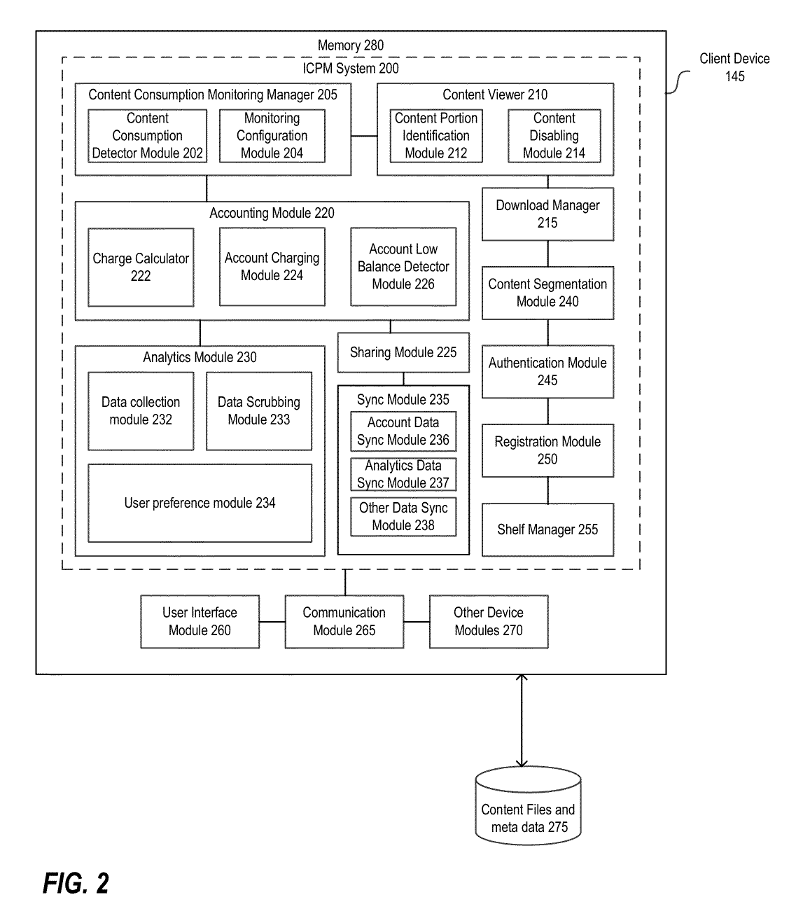

Example components of the ICPM system 200 stored in memory 280 of a client device 145 are illustrated in FIG. 2. One or more of the illustrated components may be consolidated into a single component in some implementations. The ICPM system 200 may include a content consumption monitoring manager 205, a content viewer 210, a download manager 215, an accounting module 220, a sharing module 225, an analytics module 230, a sync module 235, a content segmentation module 240, an authentication module 245, a registration module 250, a shelf manager 255, a user interface module 260, a communication module 265, and/or other device modules 270.

The content viewer 210 is responsible for rendering the e-book content selected by a user for display on the client device 145. The content viewer 210 may render text, image and the like on the screen of the client device 145. The content viewer 210 may support various e-book formats and layouts, fonts, font sizes, page margins, background and font colors, page views (single page or multiple pages displayed at any given time on a screen) and/or the like. The content viewer 210 may further support functions such as search, scroll, page turn, book marks, navigation to table of contents or selected page, and the like.

The content viewer 210 may include additional modules such as a content portion identification module 212 and a content disabling module 214. The content portion identification module 212 identifies the portion of an e-book displayed at any given time on the screen of the client device. Unlike a book in print where the pages are predefined and fixed, an e-book has “electronic pages” which can comprise more or less text based on the font, font size, margin, size and orientation of the screen of a client device, and/or the like. In one implementation, the content portion identification module 212 identifies the e-book portion based on characteristics that are independent of the display settings, or device type and orientation. For example, in one implementation, the content portion identification module 212 identifies an e-book portion based on the first and the last word, the word count (e.g., 11.3% to 11.6% of the word count), image, formula, etc., displayed on the screen. In another implementation, the first sentence, and the last sentence may be used as reference points to determine which e-book portion is being displayed, how much of the e-book content is being displayed, and the like.

The content disabling module 214 is responsible for disabling e-book content from being displayed on the screen of the client device under certain conditions. For example, when the balance on the user account is below a minimum amount, the accounting module 220 may request the content disabling module 214 to disable unpaid e-book portions so that the unpaid e-book portions are not available for user consumption. Alternately, the content disabling module 214 may also enable e-book content portions upon receiving a request to enable e-book portions for consumption from the accounting module 220. Various forms of disabling are supported by the content disabling module 214. For example, in one implementation, the e-book content portions that have not been paid for may appear faded in comparison to the paid for e-book content portions. In another implementation, a watermark may be added to the unpaid for e-book content portions to make the e-book content portion unviewable or illegible. Alternately, the content viewer may not render the unpaid e-book content portions, and instead display a notification message.

The content consumption monitoring manager 205 is responsible for monitoring consumption of e-book content on a client device, and generating charge events where applicable. The content consumption monitoring manager 205 performs the content monitoring in coordination with one or more components of the ICPM system 200. For example, the content consumption monitoring manager 205 may identify a portion of the e-book content displayed on the screen of the client device based on information from the content portion identification module 212, for example. The content consumption monitoring manager 205 may determine whether an e-book portion has been paid for and/or whether there is adequate balance in the user account to pay for unpaid portions of the content based on information from the accounting module 220.

The content consumption monitoring manager 205 may include a content consumption detector module 202 and a monitoring configuration module 204. The content consumption detector 202 may detect various events such as a read event for a portion of an e-book content that is displayed on the client device screen for a predefined length of time. The content consumption detector 202 may also detect other events that are not read events such as page browse, and take no action. The content consumption monitoring manager 205 may also keep track of the e-book content portions viewed, and based on information from other modules such as the content portion identification module 212, the content segmentation module 240, or the like, generate charge events for processing by the accounting module 220.

The monitoring configuration module 204 may be used for configuring monitoring parameters. An example monitoring parameter is a length of time a portion of the e-book content is displayed. The content consumption detector module 202 may use the length of time parameter to determine when a read event has occurred. The length of time parameter may be configured to be specific to e-books, users, time of day, geographic location, and/or the like.

Download manager 215 facilitates downloading of one or more e-books and/or e-book shelves in a single or batch mode. The download manager 215 may also coordinate and download meta data associated with e-books, information relating to promotions, price, associated rules, and the like that may be used by other modules such as the content segmentation module 240, the accounting module 220, the content consumption monitoring manager 205, and the like.

Accounting Module 220 is responsible for implementing accounting function, including determining a charge for each read portion of an e-book, monitoring and updating account balances, charging accounts for read portions of an e-book, and the like. The accounting module 220 may include a charge calculator 222, an account charging module 224, an account low balance detector module 226.

The charge calculator module 222 calculates an amount to be charged to a user account in response to charge events generated by the content consumption monitoring manager 205. The amount to be charged to the user account may depend on the charging model, which may be specific to the e-book, the user and the like. The charging model, for example, specifies an amount to be charged for a portion of the e-book. For example, an e-book costing $10.00 may be divided into 20 portions, and the user may be charged 50 cents for each portion consumed. The charge calculator module 222 may also apply any discount or promotion applicable when calculating the amount to be charged.

The account charging module 224 is responsible for reporting the calculated charge (e.g., from the charge calculator 222) to the host server 125 such that the associated user can be billed the charged amount, or a credit card on file on the host server 125 can be charged the charge amount. The account charging module 224, in order to perform the reporting to the host server 125, may determine when the client device is online (e.g., connected to the cellular or Wi-Fi network) and establish a connection with the host server 125.

The account low balance detector module 226 is responsible for keeping track of the user account balance. In some embodiments, some e-books in the client device may be associated with other user accounts. For example, when an e-book is received as a gift, the charges pertaining to the e-book can be associated with a user account of the gift giver. In such cases, the account low balance detector module 226 can also keep track of the balance on the gift giver's user account. The account low balance detector module 226 may have a minimum or a threshold balance amount associated with it. When the balance is equal to or closer to the threshold balance amount, the account low balance detector module 226 generates a disable event to the content disabling module 214 to disable any unpaid for portions of the e-book such that the unpaid portions of the e-book cannot be consumed by the user.

The sharing module 225 may include the necessary tools, plug-ins or interfaces to allow sharing of e-books, comments, messages, posts, and/or the like with other users of the ICPM system and/or external sites. Various application programming interfaces (APIs) may be implemented to facilitate the interaction between the ICPM client application and peers, and external sites. In one implementation, the sharing module 225 may also report each sharing activity to the analytics module such that data relating to the sharing activities can be collected and analyzed.

The analytics module 230 aggregates and processes data relating to a user's consumption of e-books. The analytics module 230, in one embodiment, allows the user to configure preferences for aggregating, processing, distributing, and/or usage of consumption behavior data. The analytics module 230 may include a data collection module 232, a data scrubbing module 233 and a user preference module 234, among others.

The data collection module 232 may collect data relating to user interaction with the ICPM application on the client device. In one embodiment, the data collection module 232 may aggregate data such as, but not limited to: e-books downloaded, e-book opened, e-book started, content displayed, page forward, page backward, geographical location of the user, use of table of contents, use of search tools, pages skipped, go to specific portions of an e-book, bookmark creation, highlight creation, adding remarks or comments, rating of e-books or portions thereof, sharing and/or mode of sharing (email, Facebook, etc.), clicking of links present in e-books, watching/listening to video/audio linked or embedded in e-books, use of interactive elements (e.g., quizzes, questionnaires, animations, etc.) of the e-book, e-books gifted, e-books recommended, and/or the like. In one embodiment, the data scrubbing module 233 may be included in the analytics module 230. The data scrubbing module 233 may be responsible for removing user name attribution from some of the data collected to obtain anonymized data. The anonymized data may be used to generate statistics relating to e-books, reading behavior, and/or the like.

In one embodiment, the user preference module 234 may be included in the analytics module 230 to obtain user permissions and configurations for collecting data relating to user interaction with the client application to personalize the user's experience with the client application, provide recommendations, provide analytics data to content provider, and the like.

In one embodiment, the sync module 235 may be implemented in the ICPM system 200. The sync module 235 is responsible for synchronizing data between the client application and the host server. The sync module 235 may include an account data sync module 236, an analytics data sync module 237 and other data sync module 238. The account data sync module 236 is responsible for reporting charge events to the host server. When the client device is offline, the accounting module 220 responds to charge events, and decrements calculated charge from the account balance. When the client device goes online, and a connection with the host server is established to report the charge events, such that the user account or the card on file can be charged the amount pertaining to the charge events.

The analytics data sync module 237 is responsible for synchronizing analytics data aggregated and/or processed by the analytics module 230. Whenever new data is available or when a connection to the host server is established or otherwise available, the analytics data sync module 237 may upload aggregated and/or processed data to the host server. The analytics data sync module 237 may also be responsible for downloading analytics data relating to e-books in the user's library, general or user-specific statistics, and the like from the host server to the client device. The other data sync module 238 may be responsible for synchronizing other data between the client device and the host server. Examples of other data that may be synchronized include, for example, data relating to e-books present on the client device. For example, highlight or bookmark data from other users of the ICPM system may be downloaded to the ICPM application on the client device, or uploaded to the host server from the client device.

The content segmentation module 240 is responsible for dividing an e-book into multiple segments, each of which can be associated with a read event and/or a charge amount. An e-book segment may be defined as a portion of the e-book content displayed on a display area of the client device. Since the portion of the e-book content that can be displayed on a display area of the client device can depend on the size of the client device, the orientation of the client device, and user preferences (e.g., font type and size, margin, etc.), segmentation of an e-book is not predefined, and can be changed on the fly. For example, an e-book on a landscape view may be segmented into 2612 electronic pages, and the same e-book on a portrait view may be segmented into 1392 electronic pages. The number of segments or electronic pages into which an e-book is divided at any given time may be used by the content consumption monitoring manager 205 and the account module 220 to monitor and determine charge corresponding to each segment.

The authentication module 245 is responsible for authenticating the user for a reading session or a communication session with the personal download center 105, the content server 110 and/or the host server 125. Two or more factor-based authentication methods may be used, for example, to authenticate the user and/or the client.

The registration module 250 may allow one time registration of a user. Via registration, the user's identification information such as name, address, phone number, email address, and the like is obtained. The user is asked to create a user ID and password for authenticating future sessions. During registration, the user's payment details such as bank account number, payment card number, etc., and billing address information can also be obtained. In some implementations, the registration module 250 may also obtain user preferences regarding favorites, sharing, data collection, and the like. At least some of the information obtained by the user during registration is used to create a user profile.

The shelf manager 255 is responsible for managing the e-book shelves. E-book shelves allow users to organize, manage, classify and share their digital libraries. The shelf manager 255 keeps track of the e-books in various shelves, suggests e-books to add or remove from shelves, adds or removes e-books from the shelves (e.g., e.g., add new e-books to the “new e-book shelf” or remove read e-books from “to read shelf” to “finished shelf,” etc.), and the like. The shelf manager 255 may also facilitate sharing of one or more shelves including all the e-books therein with other users, collaborate on curating of an e-book shelf, and/or the like. The collaboration feature may allow a select group of users (e.g., users invited by the creator) to view, download and synchronize when the contents of a shelf is changed, suggest e-books for addition or removal, and/or the like. The shelves created by each user may be reported to the host server for storage in a remote database table (e.g., database table 378). The shelf manager 255 may report or provide for reporting information such as a the user ID of the creator, identifiers of the e-books in the shelf, lock or unlock status, date and time of creation, privacy option (e.g., private or public), metadata or tags for the shelf, and the like.

The import, export and share features of the shelf manager may be applicable only to the users of the client application, where an upfront purchase of any of the e-books on the shelf is not needed. A user of the client application can select and download a shelf (and the e-books therein) to his or her personal library, and pay for the books as he or she reads them.

In one embodiment, the ICPM system 200 may include a check in module (not shown) that uses location data and current reading activity of users to identify the e-books that are being consumed at any given near the geographical location of a user. For example, if a user is in the Central Park, the user can invoke the check in module to get a list of e-books currently being read by other users in the Central Park or area around the Central Park. In one implementation, the actual names and geographical locations of users are not disclosed to maintain their privacy. In some implementations, the check-in module may include an option where a user can check in to share the location and e-book information. In a further implementation, a user can do a private check in where group of readers selected by a user can see the user's location, e-book, and name, for example.

In addition to the components described above, the client device may also include a user interface module 260 that is responsible for rendering the user interfaces associated with the client application and other native user interfaces. The client device may also include a communication module 265 to facilitate communication between the various components of the ICPM system 200, and other components and external entities such as the host server, the personal download center, and/or the content server. Various other mobile device modules 270 may be included in the client device.

In one implementation, the client application may store data to and access data from a storage area 275 in the memory. The storage area may store, for example, content files (e-book files) downloaded to the client device, metadata, analytics for display, and the like.

Example ICPM System Components On The Server(s)

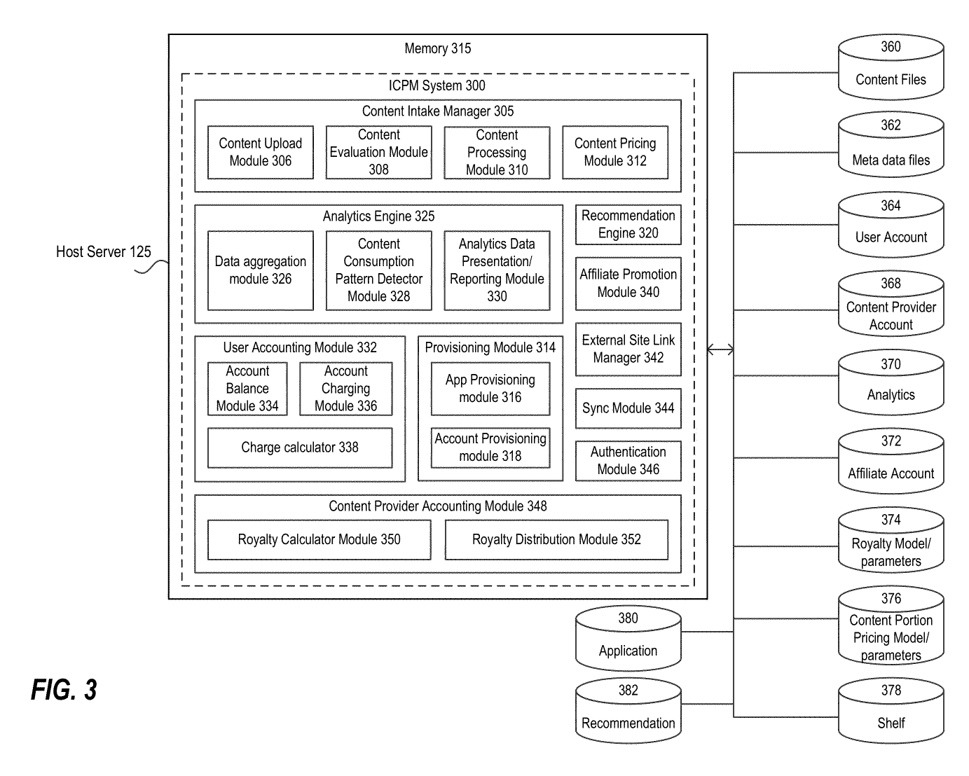

Example components of the ICPM system 300 are illustrated in FIG. 3. In one embodiment, memory 315 of the host server 125 may store all or some of the components of the ICPM system 300. In another embodiment, some of the components such as the content intake manager 305 may be implemented on the content server 110.

The content intake manager 305 may include a content upload module 306 that allows content providers to upload e-books in a variety of formats such as doc, pdf, epub, azw, mobi, scanned images, and/or the like. E-book content files uploaded in various formats may be converted to one or more standard or preferred formats by a content processing module 310. The content upload module 306 may also include facilities for content providers to upload metadata files in various formats (e.g., XML file, xls file, etc.). The content evaluation module 308 may evaluate the uploaded e-books based on one or more criteria such as, but not limited to: difficulty level, content type, content size, similarity with other e-books available in the content server (e.g., based on metadata), and the like. Results from the evaluation may be provided to a content pricing module 312 to facilitate selection or creation of a suitable charging model for the uploaded e-book content.

In one embodiment, the content pricing module 312 selects, modifies or generates a charging model for one or more e-books and associates the charging model with the e-books. A charging model may define a set of parameters based on which a user is charged an amount for consuming a portion of an e-book. For example, a charging model can determine a charge amount corresponding to usage of x % of an e-book. Based on the input parameters selected and/or defined, a charging model can generate a charge structure that is responsive to an event or a combination of events.

In one implementation, a charging model may be generated or selected and associated with an e-book at the time of the upload. In some implementations, the charging model associated with an e-book may be modified at a later time, or when desired. In one implementation, the content provider may configure and/or select a suitable charging model for association with an e-book or a group of e-books. In a further implementation, a charging model may be preconfigured and automatically applied to all e-books or e-books matching certain conditions. For example, a publisher ABC may pre-configure two charging models—charging model A and charging model B, and specify that charging model A be applied to all self-help e-books, and charging model B be applied to all fiction e-books.

The content pricing module 312 may receive a set of input parameters to generate a charging model that determines the actual charge to a user. These input parameters may include, but are not limited to: size of content segment (e.g. # of pages), type of content segment (e.g. text, pictures, audio, video), size and type of an e-book, location of content within an e-book, time, price, previously purchased e-books, e-books likely to be purchased, geographical location of the user, and/or the like. The content pricing module 312 may, in one implementation, also receive inputs relating to promotions or offers to be applied to a charging model. Example promotions or offers may include, but are not limited to: first n number of pages free, any n pages free, first n pages free on a particular date, time, geographical location, etc., free n pages tomorrow if the user reads m pages today, and/or the like. In some implementations, the content pricing module 312 may generate charging models that are configured to: charge an upfront amount, and then charge based on usage, provide a discount for frantic reading, free n minutes on the next e-book by same author, free reading till the end of the month if a user has paid at least $x since the beginning of the month, charge a penalty if consumption level is below a threshold per period of time (e.g., 1000 pages this month), discount if the user consumes an e-book in its entirety in less than n hours, fixed charge of $x for reading a certain portion of an e-book (e.g., last 20 pages), free reading in the premises of a specific restaurant or while doing a specific activity (e.g., riding a subway), offer differential pricing for different portions of an e-book (e.g. 25% off for pages 20-40), and/or the like.

In one implementation, the charging model may include a location sensitive payment component, which applies a charge accrued by a user in a specific location (e.g., a coffee shop) to an account of the coffee shop, and any charge accrued by the user when he or she is outside of or away from the location (e.g., as detected by disconnection from the coffee shop Wi-Fi or based on the client device location) is applied to his or her own account.

The content intake manager components may access data from and store data to one or more database tables such as the content files database table 360, the metadata files database table 362, content pricing model parameters database table 376, and the like. The content files database table may include data fields such as, but not limited to: a file ID, a file name, a file size, file formats, date created or added, a provider ID, a charge model ID, ISBN number, and the like. Metadata files database table 362 may include data fields such as, but not limited to: a file ID, a genre, an author, a publisher ID, last update date, other metadata fields, and the like. Content pricing model parameters database table 376 may include data fields such as, but not limited to: file ID, promotion, content portion, price for content portion, and the like.

In one embodiment, the host server may also include a provisioning module 314. The provisioning module 314 may manage applications for various platforms, perform application version control, identify and provide applications requested for download to client devices, initiate registration and creation of accounts including user accounts, content provider accounts, and/or the like. The application provisioning module 316 may have access to one or more databases and/or database tables (e.g., application database table 380) to determine an application version supported by the client device and provide the application for download to client device. The account provisioning module 318 may create user accounts, provide appropriate access to the user accounts, provide necessary resources for managing the user accounts, requesting and verifying payment information for funding the user accounts, creating user profiles, and so on.

The provisioning module 314 may access provisioning data from and store provisioning data to one or more database tables such as the application table 380. The application table 380 may include data fields such as, but not limited to: application ID, provisioning date, application type, client device ID, user ID, and the like.

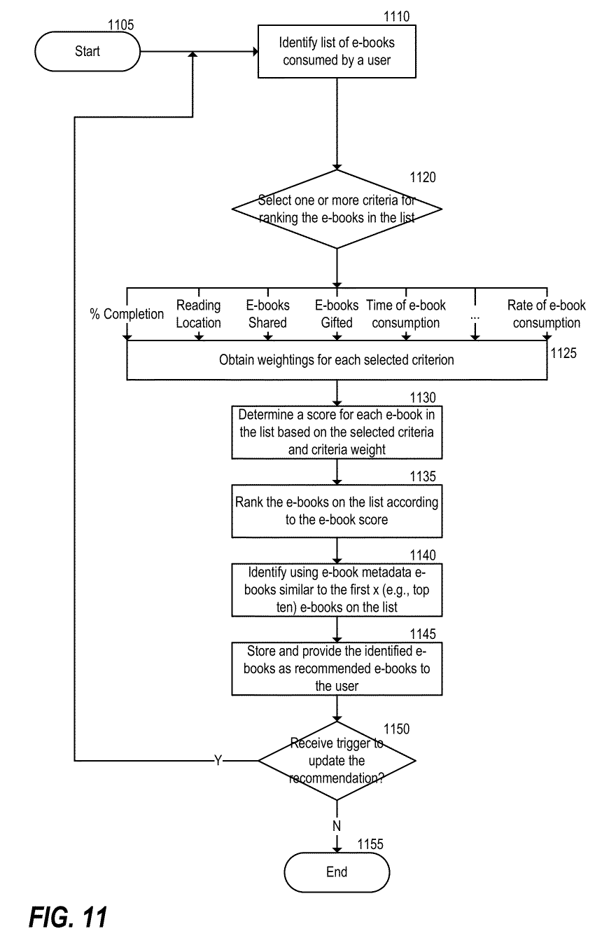

In one embodiment, the host server 125 may include a recommendation engine 320. The recommendation engine 320 may generate e-book recommendations for the user based on the user's reading and non-reading activity history, and any other data aggregated and/or processed by the ICPM system. The recommendation engine may identify reading-patterns of users to generate recommendations. The recommendation engine may identify reading patterns of users based on e-books downloaded, purchased or browsed. In some implementations, the recommendation engine may also consider e-books that have been favorited, gifted, shared, commented, bookmarked, and the like by the user. The recommendation engine 320 may also support, and personalize the personal download center 105. When a user accesses the download center 105 from his or her client application or via a browser, the user is provided a personalized store that includes e-books that the user is likely to consume. In one implementation, the personal download center may also include a default view that is not customized for the user, but is an organized and searchable catalogue of e-books available for download by the user. The recommendation engine 320 is discussed in detail with respect to FIG. 11.

The recommendation engine 320 may access data for generating recommendation from and store recommendation data to one or more database tables such as the analytics table 370, user account table 364, the recommendation table 382, and the like. The recommendation table 382 may include data fields such as, but not limited to: user ID, recommendation criteria, recommendation criteria weight, recommended e-books, e-book recommendation scores, and the like.

The host server 125, in one embodiment, may include an analytics engine 325 that aggregates data relating to user interaction with e-book content, analyzes the aggregated data to generate various statistics, reports, usage and/or behavioral patterns, and the like, and presents at least some of the results to the users and content providers. The analytics engine 325 may feed some of the aggregated and/or processed data and/or results to other modules such as the recommendation engine 320.

The analytics engine 325 may comprise a data aggregation module 326, a content consumption pattern detector module 328 and an analytics data presentation/reporting module 330. The data aggregation module 326 may determine and/or define the type of data to be aggregated from users. The data that may be aggregated by the data aggregation module 326 may include all or some of the data collected by the data collection module 232.

In one embodiment, the content consumption pattern detector module 328 analyzes the data aggregated by the data aggregation module 326 to detect content consumption patterns. The consumption patterns may be associated with a user or a group of users. In one implementation, the content consumption pattern detector module 328 may select data associated with a specific user, and analyze the selected data using various filters to establish the user's consumption pattern. For example, by analyzing data relating to e-book purchases over a twelve month period, the content consumption pattern detector module 328 may detect a spike in consumption behavior during June and July. By specifically looking at June and July consumption data, further correspondence between specific type of e-books and reader demographics may be established. These insights relating to the user's consumption pattern may be used to offer promotions or offers, or generate improved recommendations, and so on.

In another implementation, the content consumption pattern detector module 328 can not only detect completion or abandonment of an e-book, but also when a user is likely to abandon the e-book. The content consumption pattern detector module 328 can detect or anticipate such events and proactively activate or suggest promotional activities or offers to encourage completion of the e-book.

In another implementation, the content consumption pattern detector module 328 can keep track of the bread crumb trail of readers as they engage in reading activities on the ICPM system. The bread crumb trail can show the reading history of a reader and identify a book or events that led to another book or event, and so on. The pattern detector module 328 can identify and define various communities of readers, how the communities relate to each other, and how the communities change over time. Such patterns and insights may be valuable for promoting books and reading in general.

By way of another example, the content consumption pattern detector module 328, may analyze consumption data to determine the average amount of time a user takes to read an electronic page, average number of electronic pages the user reads in a single session, time lapse between reading sessions on weekdays, weekends, day, night, and/or the like. In one implementation, the pattern detected may then be used to adjust parameters such as the qualify-as-read parameter, the triggering of charge events, and/or the like.

The content consumption pattern detector module 328 may also analyze data aggregated from all users or a group of users selected based on one or more criteria. Example criteria can include, but are not limited to: geographic location, age group, gender, time of reading, profession, and the like to generate consumption statistics, parameters, trends and/or other indicators. The generated statistics, parameters or other indicators may be useful to the users, content providers (e.g., publishers, marketers), and/or the like. Example indicators that can be generated by the content consumption pattern detector module 328 include, but are not limited to: fastest read e-books (i.e., page turners or e-books with the shortest average time lapse between start and finish), most completed e-books (i.e., e-books with the best ratio of number of people who completed the e-book divided by the number of people who started the e-book), most active e-books (e-books that generated the highest number of activities such as sharing, quoting, sending, rating, and the like), most engaging e-books men/women read at night, most popular books in Palo Alto last week, location where a certain book is read, books being read in a user's location (e.g., reading by zip code), and/or the like.

Additional examples of indicators generated by the ICPM system include, but are not limited to: a completion indicator representing the ratio of users who downloaded an e-book to those who completed the e-book, an abandonment indicator representing the ration of users who downloaded an e-book to those who abandoned the e-book at some point along the way, an overall activity indicator that is a weighted score calculated based on non-reading activity (e.g., sharing, commenting, quoting, and the like), geographical growth and distribution map showing the physical location of readers, identifying clusters and how the clusters are growing, shrinking, shifting, and the like.

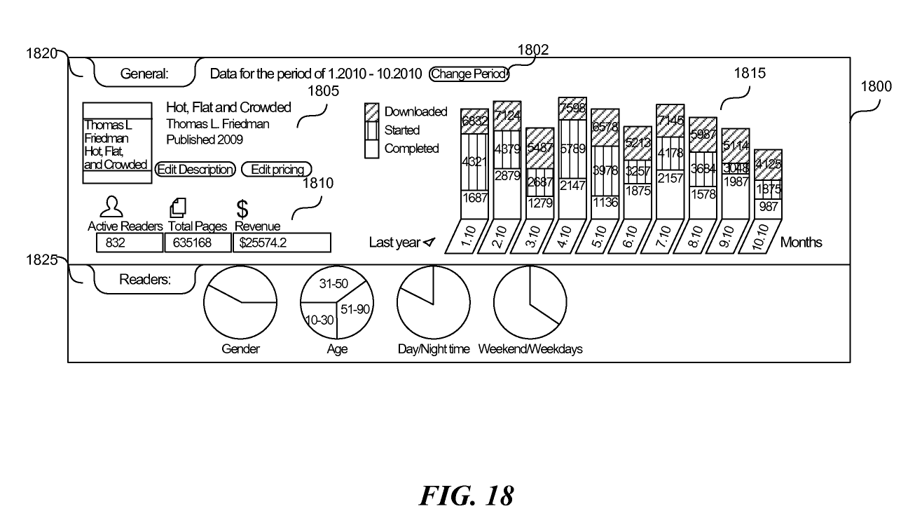

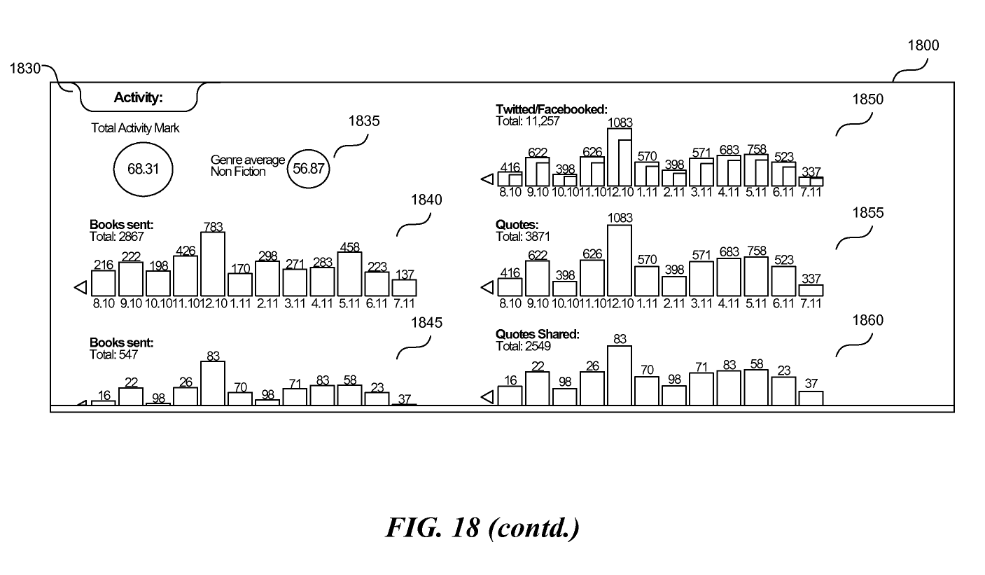

The analytics data presentation/reporting module 330, in one embodiment, may include user interfaces for content providers to configure filters for obtaining a subset of analytics data, instructing the content consumption pattern detector 328 to analyze the selected subset of analytics data, and present the results of the analysis in various graphical, textual and/or other reporting formats. For example, a content provider participating in the ICPM system may select a specific time period, and a specific e-book from a user interface or dashboard (e.g., dashboard illustrated in FIG. 18). The analytics data presentation/reporting module 330 may then provide the time and e-book title filters to the content consumption pattern detector module 328 for analyzing data according to the selected filters. The results of the analysis may be provided to the analytics data presentation/reporting module 330 for presentation as a chart, table, a spreadsheet, and/or the like.

The analytics engine may store data to and access data from one or more database tables such as the Analytics table 370, the content files table 360, the metadata files table 362, and the like. The analytics table 370 may include data fields such as, but not limited to: a file ID, number of downloads, date/time, number of reads, geographical location, and the like. Other analytics data examples described in detail with respect to the analytics engine 325 may also be stored in the analytics table 370.

In some implementations, the analytics engine 325 may also include a shelf analytics module (not shown) that monitors activities relating to shelves, such as the number of downloads, shares, links, views, and the like. Based on the shelf activity data, most popular or most influential shelves can be identified. The creators of the top x number of most influential shelves may be compensated by the ICPM system.

In one embodiment, a user accounting module 332 may be included in the host server 125. The user accounting module 332 may be responsible for managing user accounts, account balances, charging appropriate amounts when triggered, and the like. The account balance module 334, in one implementation, manages the account balance of the user account. For example, if the balance on a user account is running low (e.g., below a threshold), the account balance module 334 may generate a notification reminding the user to top up the user account. If the user has set up an automatic refill, the account balance module 334 may instead request the account charging module 336 to refill the user account with predefined amount of funds by sending a charge request to a bank or issuer of the payment card account on file for the user. In one implementation, when the user account is set up for direct billing to a payment card or bank account, the account charging module 336 may send charge requests to the financial institution associated with the payment card or bank account to obtain funds corresponding to the charge requests.

In one implementation, the user accounting module 332 may also include a charge calculator 338 that determines a charge for each charge event reported by the client device using a charge model associated with the user and/or the e-book. The charge amount determined by the charge calculator 338 may be provided to the account balance module 334 to generate a current account balance (e.g., by reducing the account balance by the charge amount) and the account charging module 336 to initiate charge requests in case of direct billing.

The user accounting module 332 may retrieve and/or store user accounting information in one or more database tables such as the user account database table 364. The user account database table 364 may include data fields such as, but not limited to: a user ID, email address, registered device ID, phone number, billing address, payment account identifier, auto-refill option, password, current account balance, payment due date, account status (e.g., on hold, active, inactive) and the like.

In one embodiment, an affiliate promotion module 340 may be included in the ICPM system 300. The affiliate promotion module 340 allows users and content providers to create, export and promote e-books via the shelf system, the book voyage, and/or the like. The affiliate promotion module 340 can track the user activities that brought about reading and incremental purchase, and can compensate the users who created and/or promoted the e-book shelf, the book voyage, and the like. In one implementation, the compensation may include financial compensation (e.g., an amount), purchase discount, free reading, rewards in the form of badges, titles, and the like.

The affiliate promotion module 340 may store data into and access data from one or more database tables such as the affiliate account database table 372. The affiliate account database table 372 may include data fields such as, but not limited to: affiliate account ID, shelf ID, book voyage ID, e-book ID, promotion type, activity points accrued from promotions, and the like.

In one embodiment, the ICPM system 300 may include an external site link manager 342 to link, manage, and otherwise support the ICPM system to external sites 135. The external site link manager 342 may manage the APIs associated with external sites, make and/or facilitate API calls to external sites to pull or push data, and the like.

In another embodiment, the ICPM system 300 may include a sync module 344 that synchronizes data including accounting, e-book, analytics and other data between the host server, and/or the content server, and the client devices. The sync module 344 start a sync session with one or more client devices when there is a change or new accounting, e-book, analytics, and other relevant data available. In a further implementation, the sync module 344 may start a sync session based on a schedule. For example, the sync module 344 may start a sync session if the last sync session was more than two weeks ago. The sync module 344 may also coordinate syncing when the sync is initiated from the client side.

In one embodiment, ICPM system 300 may include an authentication module 346 for authenticating users and content providers for accessing the facilities of the host server, including access to user and content provider accounts, personalized download center, client application, and the like. The authentication may be based on two or more factors of authentication, for example. The authentication module 346 may access data from the user account database table 364 and the content provider account database table 368 to perform authenticate users and content providers respectively.

Some embodiments of the host server may also include a content provider accounting module 348 to manage content provider accounts, track incremental purchase of e- books and associate each incremental purchase with one or more content provider accounts, determine royalties based on an agreed upon royalty model and distribute payments in the form of royalties to parties such as authors (e.g., direct publishing), publishers, and the like. The royalty calculator module 350, in one implementation, may calculate royalties owed to authors (e.g., direct publishing) based on a royalty model which may take into account the retail or sale price of each e-book or e-book segments that are associated with a charge, geographic location of the incremental purchase or the user account, a royalty rate associated with the geographical location (e.g., royalty rate of 60% of net in the United States), and the like. The royalty calculator module 350, in another implementation, may calculate the net payment amount owed to content providers who are agency or wholesale publishers, for example. The net payment amount may be determined based on a fee charged by the ICPM system for marketing, distribution and/or selling e-books and the actual retail or sale price of e-books or e-book segments. The royalty distribution module 352, in one implementation, may generate statements on marketing and/or sale of e-books/e-book segments and distribute payments owed to various parties on a periodic basis. The royalty distribution module 352 may, for example, make direct deposits to bank or payment accounts of the parties involved.

The content provider accounting module 348 may access data from and store data to one or more database tables such as the content provider account database table 368, the royalty model parameters database table 374. The content provider account database table 368 may include data fields such as, but not limited to: a provider ID, a provider name, a provider type (e.g., direct publisher, agency publisher, wholesale publisher, etc.), an email address, physical address, royalty model ID, password, and the like. The royalty model parameters database table 374 may include data fields such as, but not limited to: royalty ID, royalty percentage, royalty period, current payment due, payment due date, geographical location, and the like.

In one implementation, the ICPM system 300 may have include a shelf database table 378 for storing and accessing data relating to shelves. The shelf table 378 may include data fields such as, but not limited to: shelf ID, creator ID, e-book ID, status (lock or unlock), date and time of creation, privacy status (e.g., private or public), metadata or tags, and the like.

Other ICPM System Components

Some embodiments of the ICPM system (on the client device, the host server, the content server and/or the personal download center) may include components in addition to the ones described above. For example, one embodiment of the ICPM system includes an advertising module to target select users and/or e-books for in e-book advertisements. Based on the aggregated data relating to the reading behavior and activities of users, and in some cases, reading location of users, the e-book being read, the advertising module can identify relevant advertising messages and deliver such messages to users. The advertising module may also be able to aggregate data relating to exposure of readers to advertisements to generate various metrics that can be used to gauge the effectiveness of advertising messages.

One embodiment of the ICPM system may include a campaign module that allows content providers such as writers and publishers, individual readers or a group of readers to link their reading activity to campaigns. For example, every time a user reads an e-book or a part of an e-book, a certain portion of the revenue may be channeled to a charitable cause. The campaign module may include facilities for users and content providers to easily configure, manage and promote campaigns (e.g., read for cancer research campaign) and manage finances.

One embodiment of the ICPM system may include a group reading module that allows simultaneous reading of one or more portions of an e-book. A client device designated as a master is linked to multiple client devices to create a group reading session. The page turns, highlights, and the like, may be synchronized between the master and the client devices linked to the master, such that all readers are exposed the same portion of the e-book as the master.

One embodiment of the ICPM system may include an e-book queue manager that queues up e-books. Once a reader completes reading an e-book, the next e-book on the queue is automatically displayed, without the user having to go back to the library view or the personal download center to look for the next book to read. In one implementation, the queue may be configured by the user, or may be built automatically based on system generated recommendations, or a combination thereof.

One embodiment of the ICPM system may include a quote collection module that collects all the highlights, quotes, selected portions, and the like from e-books read by the user. The module, automatically or based on user input, generates an e-book including all or selected quotes stored by the quote collection module. The generated e-book may be updated whenever new data is available. In some implementations, the user can also apply various formatting and layout options or use templates to format the e-book as desired. The generated e-book can be shared, emailed, uploaded to the content server for distribution to other users, sent to a printer for printing, and the like. The user can also monetize the generated e-book if desired.

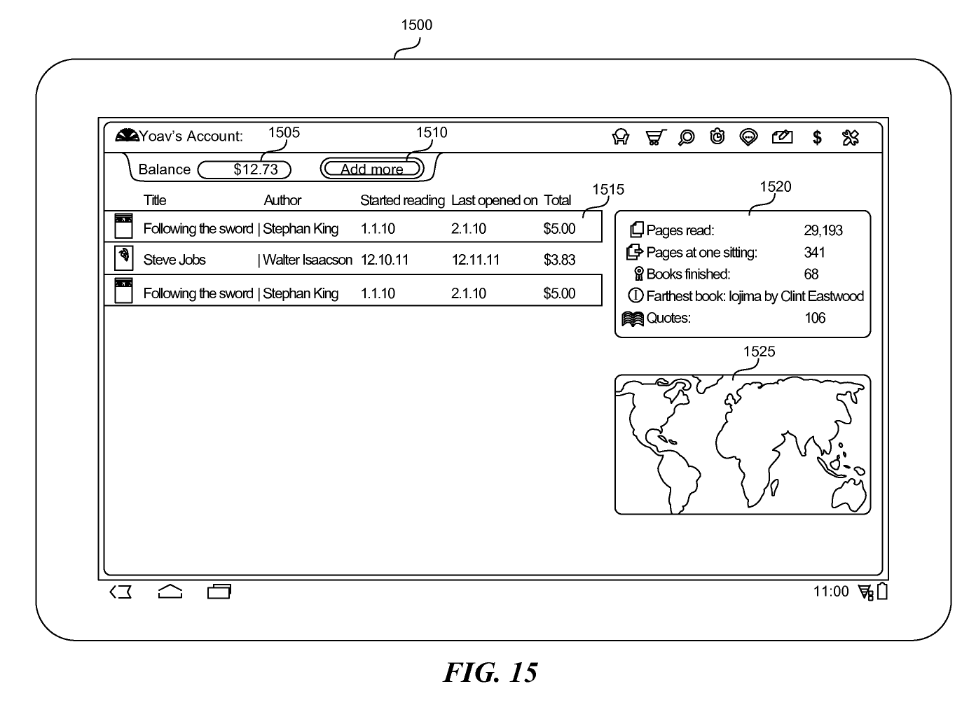

One embodiment of the ICPM system may include a mapping module that identifies, on a map, the location where a user read one or more e-books (or portions of e-books) with an indicator. For example, the map 1525 on the user interface 1500 of FIG. 15 may be generated using data (e.g., location and e-book) by the mapping module.

One embodiment of the ICPM system may include a funding module that requests and/or accepts financial contribution from a user for a recipient, obtains the contribution amount from the user's account or bank or payment card account, and provides all or a portion of the contribution amount to the recipient. A recipient may include an author, for example. The financial contribution may be tracked, and may be used to offset the cost of reading the author's next book.

In one embodiment of the ICPM system, in addition to the user account, which is an individual account, there may be an option to open a family account. A family account module may then facilitate creation of a family account including two or more users (e.g., members of a family). In one implementation, funds in the family account may be applied towards charges initiating from multiple user accounts and/or client devices. In one implementation, e-book portions incrementally purchased by a family account member may have special ownership rights. For example, if one member of the family account completes an e-book portion or a whole e-book, one or more remaining members of the family account may be able to read the e-book portion or the whole e-book at a reduced price or at no price at all. For example, if one family account member reads a chapter at the cost of a dollar, a second member can read the same chapter at 80 cents, and then the third member can read the same chapter at 60, and finally the last member can read the same chapter at 0 cents. In another implementation, members of a family account can download e-books together and share the charge arising from the reading of the e-book by any of the members. Those users with a family account may, in some implementations, link their libraries, such that an e-book downloaded to one user's library is automatically downloaded to the client devices of all other users associated with the family account. In one implementation, the incremental charge may be reduced as more members of a family read the same portions of an e-book.

One embodiment of the ICPM system can handle audio books and text to speech conversions. In one implementation, the content consumption detector module 202 may detect play, pause, stop, forward, rewind, and the like events and determine the length of time an audio book or a text to speech conversion was played. For example, if an audio book has a total listening time of three hours and the user listens to the audio book for one hour, the user can be charged one-third of the retail/sale price of the audio book. Any of the previously described usage-based consumption and charging models and mechanisms may be applied to determine the correct charge for audio and text-to-speech media content.

One embodiment of the ICPM system can include a conditional consumption module that includes or defines and associates with one or more e-books and/or users one or more conditions for consumption or purchase. For example, one condition can specify that an e-book be consumable or purchasable only when the reader is at a certain location, performing a certain activity (e.g., riding a subway), and the like. In a further implementation, one condition may specify that when the user activity matches a specified activity, the purchase price for the associated segments or the reading session be discounted. Variations of these and other embodiments and implementations are within the scope of the application.

One embodiment of the ICPM system can include an e-book voyage module that allows users or other entities to create one or more e-book voyages. An e-book voyage may include a list of portions of one or more e-books which together form a certain experience, shed light on a certain subject, be on a certain theme, and the like. The e-book voyage module may allow users to select, for example, a paragraph, a scene, a description, a chapter, a story, a picture, a graph, and the like, include commentary or explanation, and the like. In one implementation, the e-book voyage module may place the user selections into a single shelf, which can be downloaded and/or shared as desired by the user. The commentary added by a creator of the voyage can be included as another book on the shelf, with active links to each portion of the voyage. When the link is selected, the relevant book may open directly at the portion recommended in the specific voyage.

One embodiment of the ICPM system can include a content acquisition module that can acquire content for inclusion and/or distribution in the ICPM system. In one implementation, the content acquisition module may identify, based on user activities (e.g., search for an e-book by a user or users, conversation in social media, user request, and the like), one or more e-books for addition to the ICPM system catalog. In some instances, it may be possible to enter into agreement with content providers associated with the identified e-books. In such instances, a royalty model may be selected or generated, and associated with the e-books. However, in other instances, such agreements may not be feasible or successful. In one implementation, the content acquisition module can determine whether or not to acquire an e-book for addition to the catalog based on the likelihood of a specific user or other users consuming an e-book. The likelihood or probability that an e-book will be consumed may be determined using information on the e-book, consumption history of a specific user, user interests, and/or other users. If the likelihood is high (e.g., equal to or higher than a threshold), the potential risk to the ICPM from the upfront purchase is low. The content acquisition module may then recommend the e-book for purchase by the ICPM system and/or purchase the e-book. The ICPM system may then make the e-book available for consumption/distribution on the personal download center. Thus, the ICPM system may pay the content provider the wholesale price of the e-book upfront and recover the paid price from payments from the e-book reader for the incremental purchase of the e-book. If the e-book reader does not read the e-book is part or wholly, the ICPM system incurs a loss.

Example Processing

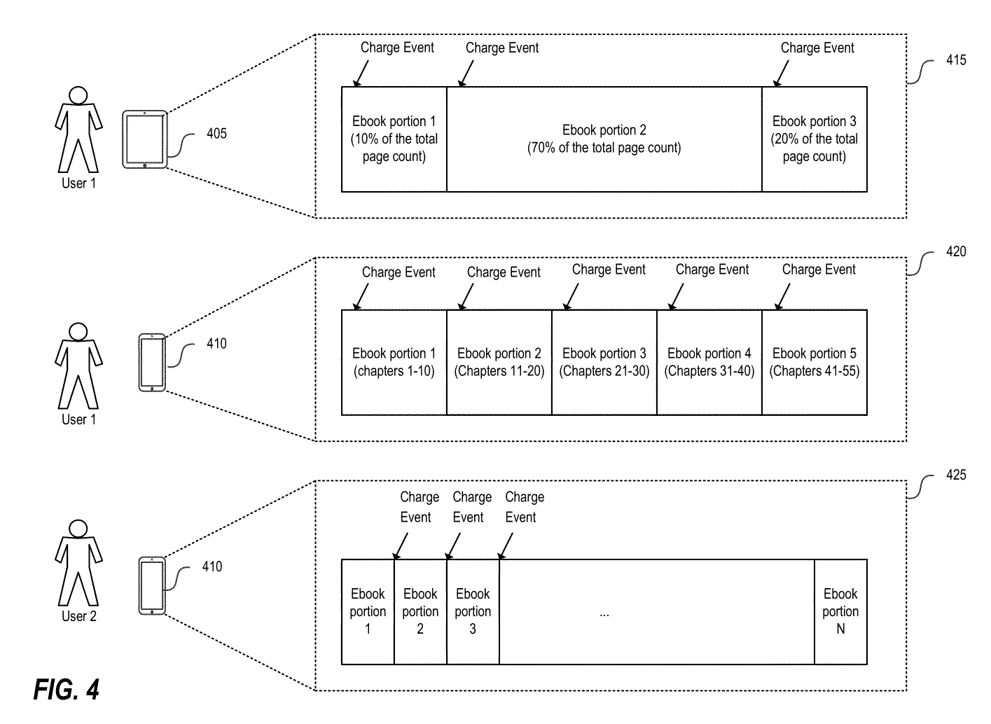

The ICPM system allows personalized segmentation of e-books, that closely follows the mode of consumption. As each segment of an e-book is consumed by the user, the ICPM system keeps track of the consumed segments. As the consumed segments add up to equal a predefined portion size, the ICPM system creates a charge, i.e., triggers a charge event. The diagram shown in FIG. 4 illustrates various ways in which e-book segments are monitored for creating charges.

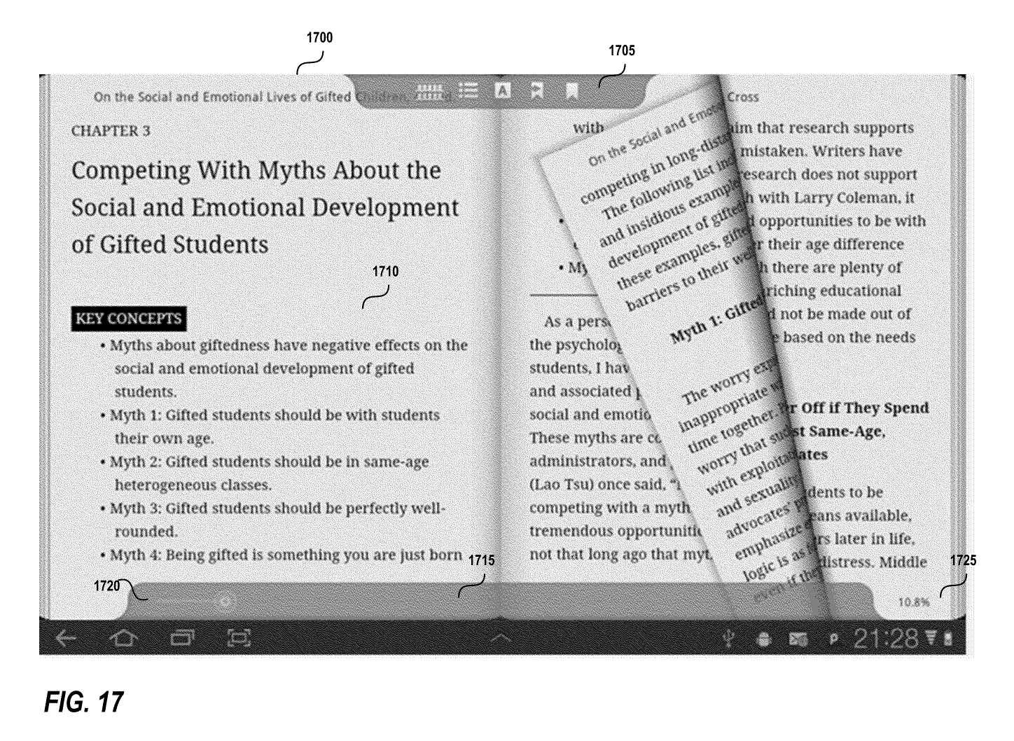

In one embodiment, for example, user 1 may have an e-book 415 on his or her client device 405. The e-book 415 may be 1000 standard pages long (e.g., known font, size, margin, screen size) divided into portions 1 (10%-100 standard pages), portion 2 (70% -700 standard pages) and portion 3 (20%-200 standard pages). When the user launches the e-book on his or her client device and chooses certain formatting options, the e-book may be reformatted to, for example, 1500 segments, where each segment is the equivalent of an electronic page that can be displayed on the client device. For example, referring to FIG. 17, two segments or two electronic pages are displayed by the content viewer using the book layout. The ratio of a standard page to a segment can be determined to be 1:1.5. When user 1 starts reading the e-book, he or she is charged 10% of the retail price of the whole e-book, allowing user 1 to read up to 150 segments in any sequence. Should user 1 change the formatting options after reading, for example, 70 e-book segments, the ratio of a standard page to a segment is calculated again. Based on the new ratio (1:2), user 1 would be allowed to read an additional 106 e-book segments before being charged for portion 2, and so on.

In another embodiment, an e-book 420 may be divided into multiple portions (e.g., portions 1-5) based on chapters. In one implementation, user 1 may open, for example, chapter 33 for reading on a client device 410. When user 1 starts reading chapter 33, a charge event may be created for e-book portion 4. User 1 may then be allowed to read chapters 31-40.

In yet another embodiment, an e-book 425 may be divided into multiple portions (1 to N). The charge may be created when user 2 has read a number of e-book segments that equal each e-book portion. For example, if each book portion is 10 pages, the e-book segments read by user 2 is added until the e-book portion read is equivalent to 10 pages (or 10% if there are 100 pages in total), at which time user 2 is charged an amount corresponding to 10% of the e-book retail or sale price. User 2 may continue reading the e-book, and may even read certain segments more than once. However, only the previously unread segments are counted to create the charge, such that user 2 is free to re-read any previously read segments without incurring further charge.

In an alternate embodiment, word count and percentage may be used to charge for the exposed segments. For example, an e-book may have 10,000 words, and a user may be exposed to an e-book portion 12% to 14% (i.e., e-book portion starts from the 1200th word and ends at the 1400th word). Various alternative ways of dividing an e-books are contemplated. For example, e-books may be divided by characters, words (e.g., create a charge when a user has read 10% of the total word count), sentences, paragraphs, parts, and the like.

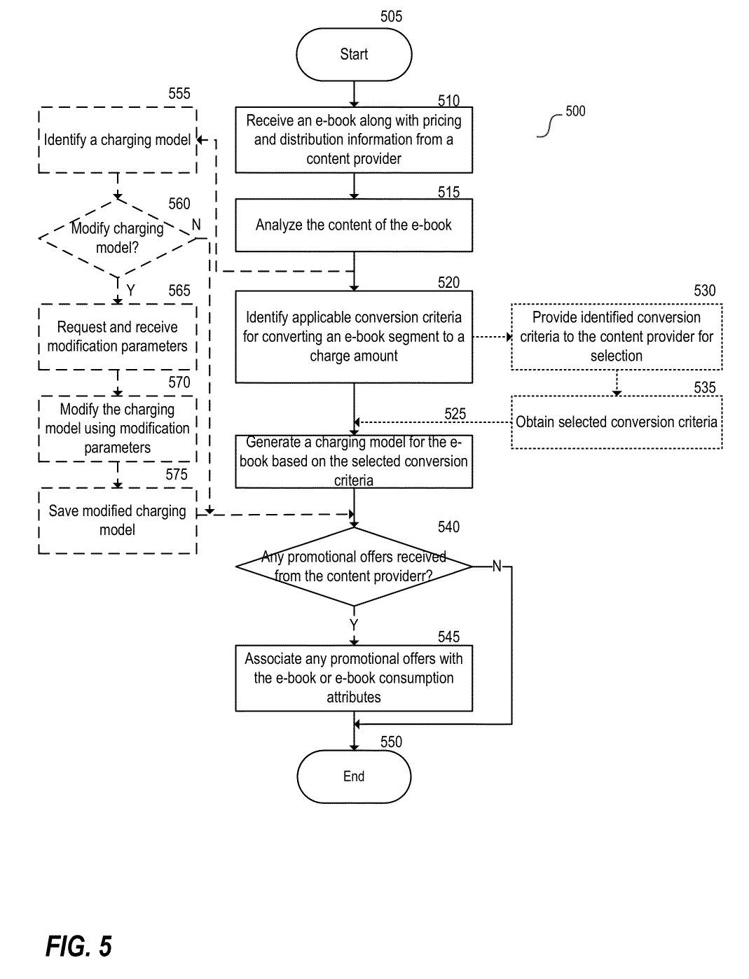

Content providers can upload e-books to the host server or the content server for distribution via various channels including the personal download center, online store, and the like. When e-books are uploaded, the content providers may specify the retail price of an e-book, and other information such as metadata, promotions or offers, other parameters, and the like. FIG. 5 is a logic flow diagram illustrating an exemplary method of managing e-book intake in one embodiment of the ICPM system.

The e-book intake may start at block 505. The content server (or the host server) may receive the e-book file, metadata file, pricing and/or distribution information provided by the content provider at block 510. Various formats of the e-book and metadata files may be accepted. At block 515, the content of the e-book may be analyzed. For example, the e-book may be analyzed to determine the total number of pages, chapters, sentences, paragraphs, words, etc., the presence of text, images, audio, video, links, animation, etc., difficulty level, retail or sale price, locations or activities mentioned in the e-book, and the like. At block 520, one or more conversion criteria that are taken into account for converting an e-book segment into a charge amount may be identified. Additional conversion criteria such as the user's purchase history, geographical location of the user, and the like may also be identified. In one implementation, the identified conversion criteria may be provided to the content provider for selection at block 530. The selections may be received from the content provider at block 535. Alternately, a default set of conversion criteria may be identified and selected at block 520. At block 525, the selected conversion criteria may be used to generate a charging model for the e-book.

In yet another implementation, based on the analysis of the e-book, a charging model may be identified at block 555. The charging model may be stored in a database table, for example. At block 560, if the content provider desires to modify the charging model, the modification parameters may be requested from the content provider, which is received at block 565. At block 570, the charging model may be modified using the received modification parameters. At block 575, the charging model may be saved or stored in a database table as a new or a modified model.

An example charging model generated using the method 500 may take into account conversion criteria including: the number of pages of the e-book (e.g., 1050 pages), number of illustrated pages (e.g., 100 pages), ratio of text to illustrated pages (e.g., 1:2), content location (e.g., Central Park) and user location matching, retail price/sale price (e.g., $10), number of charge events (e.g., 10), and the like. If a user reads an equivalent of 100 pages (e.g., 75 text pages and 50 image pages), which is 10% of the e-book, the user is charged $1. If 25 image pages were that of Central Park and the user viewed the pages in the Central Park, the charging model may apply a discount, such that the user would have read an equivalent of 87.5 pages (e.g., 75 text pages and 25 image pages), which is less than the 10% of the book, so that user would not be charged anything.

Referring to method 500, at block 540, if any promotional offers are received from the content provider, the promotional offers may be associated with the e-book and/or e-book consumption attributes at block 545. For example, a promotional offer can stipulate that if a user consumes an e-book in less than 24 hours, a 25% discount may be provided by statement credit, a gift card, and the like. The process concludes at block 550.

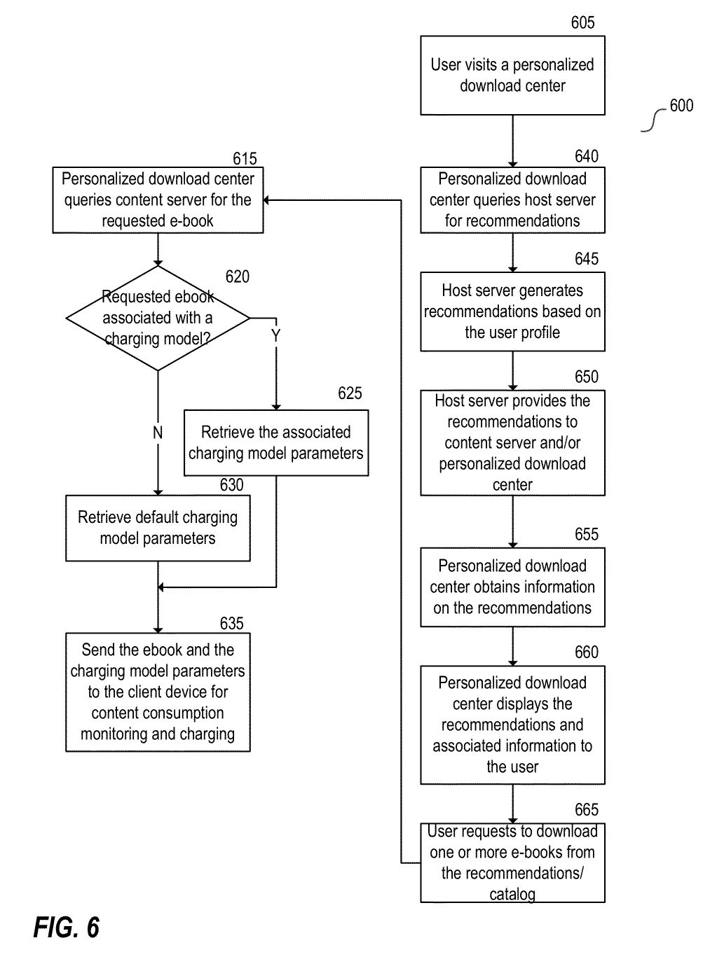

Once e-books are stored in the content server, the e-books are made available for download via the personal download center, and in some instances, via other online websites. In one implementation, a user can visit the personal download center to browse through the e-book catalog, search and/or select a specific e-book or e-books for download. In another implementation, the personal download center can be customized for the user such that the user can view e-books that are selected for the user based on the user's profile. FIG. 6 is a logic flow diagram illustrating an exemplary method of downloading an e-book from a personal download center in one embodiment of the ICPM system.

At block 605, a user visits a personal download center, using the client application, or via the web. At block 640, the personal download center queries the host server for recommendations. In one implementation, the personal download center may provide information such as user ID, browsing activity, and the like, to the host server along with the request for recommendation. The host server, at block 645 generates recommendations using, for example, the recommendation engine 320. The host server provides the recommendations to the content server and/or the personal download center at block 650. The personal download center obtains information on the recommendations (e.g., e-book names, thumb nail images, blurbs, reviews, etc.) from the content server at block 655. Alternately, the content server may send additional information on the recommendations to the personal download center. At block 660, the personal download center displays the recommendations and the associated details to the user. At block 665, the user requests to download one or more e-books from the recommendations, or from the catalog.

The personal download center queries the content server for the requested e-book at block 615. At block 620, the content server determines whether the requested e-book is associated with a charging model. If the e-book is associated with a charging model, the content server retrieves the associated charging model parameters necessary for determining the charge at block 625. If there is no associated charging model for the e-book, a default charging model may be retrieved and associated with the e-book for that particular download. Alternately, in some implementations, the host server may determine and/or update charging models specific to the user for association with the recommendations for that particular session with the personal download center. At block 635, the content server or the personalized download center provides the selected e-book or e-books to the client device for consumption and monitoring, without charging the user the sale or retail price of the e-book or e-books.

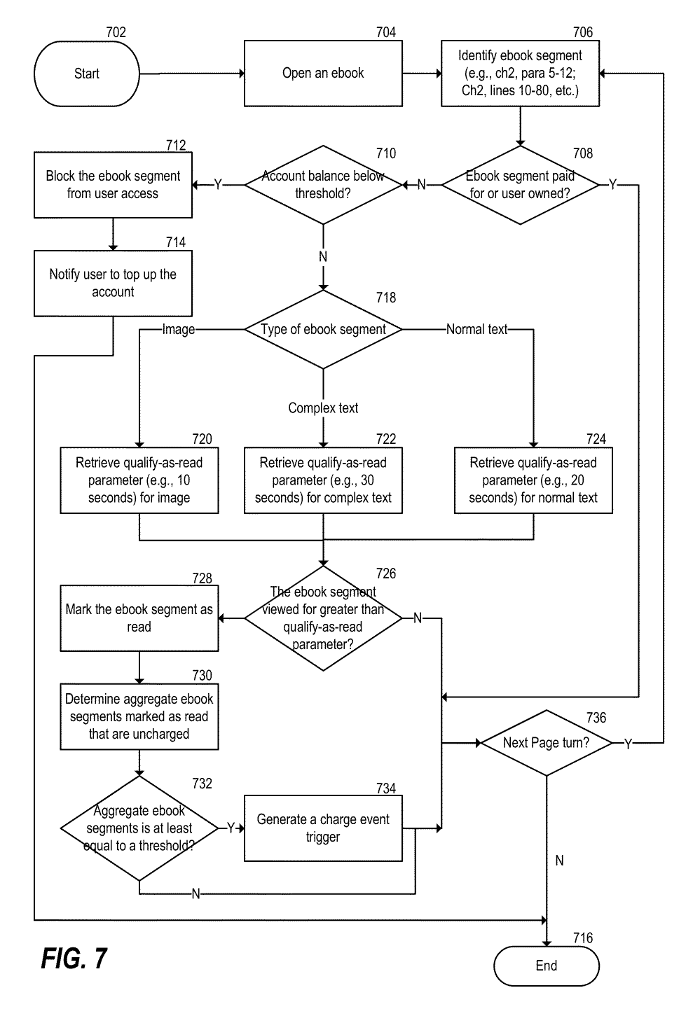

After downloading one or more e-books on his or her client device, a user can select an e-book and start reading. Once downloaded, the user can disconnect the client device from the network (e.g., Wi-Fi, cellular, etc.), and still be able to read previously paid for e-book portions as well as any previously unread e-book portions, as long as the user has enough balance in his or her account or has pre-authorized refill or direct charging to a payment card or bank account, for example. FIG. 7 is a logic flow diagram illustrating an exemplary method of monitoring e-book consumption in one embodiment of the ICPM system.

The process starts at block 702. A user opens an e-book at block 704 using his or her client application on a client device. At block 706, an e-book segment that is in view on the display area of the client device is identified. For example, the chapter, paragraph, lines, word count, words, electronic page number, etc., can be used to identify the specific content segment being viewed or read. At decision block 708, the client application determines whether the e-book segment is already paid for or owned by the user. If the e-book segment is not paid for, or not previously read, the client application, at decision block 710, determines whether the account balance associated with the e-book is below or equal to a threshold. The threshold, in one implementation, can establish a minimum amount of funds in the user account that is required for the user to continue to read. If the user account balance is above the threshold, the process moves to decision block 718. In some implementations, if the user has preauthorized refill of the user account with a predefined amount of funds from a bank or payment card account, or if the user account is directly linked to a bank account or a payment card account, and the ICPM system is authorized to make charges as necessary, the result of the decision block 710 can be overridden and the process moves to decision block 718. Alternately, if no such authorization is available, and the account balance is below a threshold as determined at decision block 710, the client application blocks the e-book segment from user access at block 712. In one implementation, the e-book segment may be blocked by changing the color of the font or the background, or by placing water marks, so that the e-book segment is not legible. In some implementations, instead of abruptly blocking an e-book segment of the account balance for being below a threshold, the client application may gradually reduce the intensity of the display, weaken the color of the font, or change display settings for the content viewer until the content is completely illegible. The gradual reduction in the legibility of the e-book content can serve as an ongoing alert to the users to increase the balance on his or her account. At block 714, the user associated with the user account that has a zero balance or a balance below a threshold is notified to top up the balance to continue reading.

At decision block 718, a determination regarding the type of e-book segment may be made at block 718. In one implementation, if the e-book segment is an image, a qualify-as-read parameter corresponding to an image can be retrieved at block 720. If the e-book segment is a complex text, a qualify-as-read parameter for a complex text is retrieved at block 722. At block 724, a qualify-as-read parameter for normal text is obtained if the type of e-book segment is a normal text. Determination of whether an e-book segment is complex, normal or image, for example, may be made based on semantic analysis of the text, recognition of the image, and the like, in one implementation. The qualify-as-read parameter, in one implementation, may be specific to the type of e-book segment such as image, complex text, normal text, and the like. In a further implementation, the qualify-as-read parameter may also be specific to the user. For example, if a user, on average, spends 10 seconds looking at an e-book segment of image type, the qualify-as-read parameter for the user can be set to 10 seconds. If the user, based on analysis of reading behavior, is a fast reader, and on average, spends 8 seconds looking at an e-book segment of image type, the qualify-as-read parameter is adjusted to be 8 seconds instead of 10 seconds for that specific user. Thus, if the user reads a segment for at least 8 seconds, the segment is counted for charging.

At decision block 726, if the e-book segment was viewed longer than or equal to the qualify-as-read parameter specific to the type of e-book segment, and/or the user, the e-book segment is marked as read, consumed, or the like at block 728. At block 730, the aggregate amount of e-book segments marked as read, that have not been charged, is determined. For example, if previously 4 e-book segments were marked as read but uncharged, the number of e-book segments is increased by 1 such that the aggregate number of read e-book segments to be reported for charging is 5. At decision block 732, a determination may be made as to whether the aggregate number of e-book segments is at least equal to a threshold. If true, the client application generates a charge event trigger at block 734. For example, when the aggregate e-book segments read is at least a threshold of 5, the charge event trigger can be generated. If the user turns the page or views another e-book segment as determined at decision block 736, the new e-book segment is identified as before at block 706. Alternately, if the user decides to close the e-book or the app, the process ends at block 716.

In an alternate embodiment, blocks 728-732 may be optional. In other words, a charge event trigger may be created after each segment is considered or marked as read.

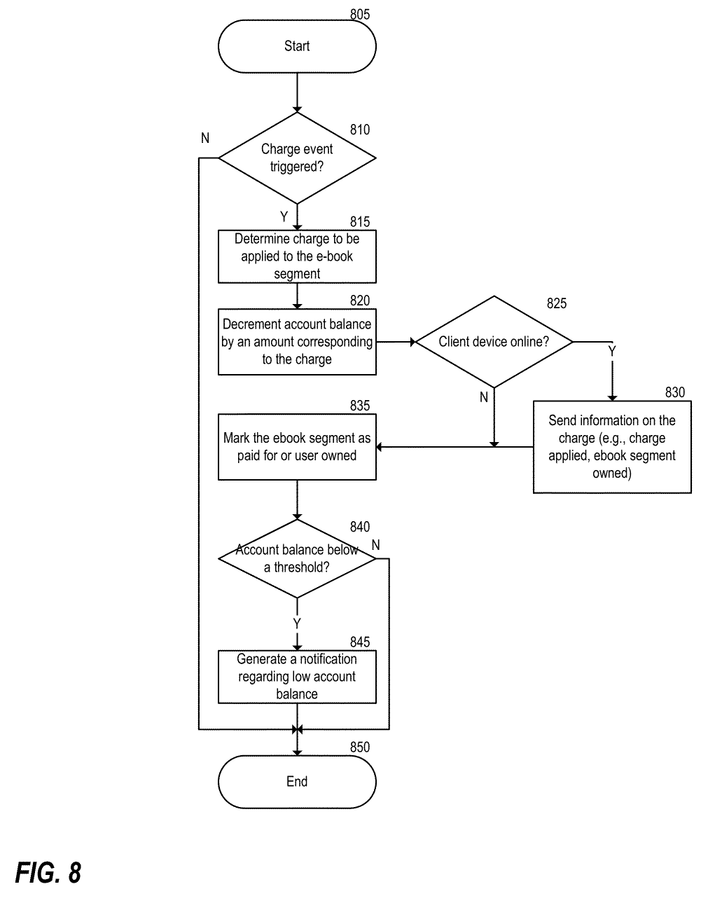

The charge event that is triggered when a certain amount of e-books segments have been consumed is used to update the account balance, either in the host server or locally in the client application. FIG. 8 is a logic flow diagram illustrating an exemplary method of charging for e-book consumption in one embodiment of the ICPM system. The process starts at block 805. At decision block 810, if the charge event is triggered, the charge to be applied is determined. For example, in one implementation, based on the aggregate e-book segments reads and the associated charge model, the charge corresponding to the charge event is determined. Alternately, the charge corresponding to the charge event may be predetermined. For example, if charge event is to be triggered when 10% of the e-book is read, the charge to be applied may be equal to 10% of the e-book's retail/sale price. In some implementations, adjustments to the charge amount based on promotions, offers, and the like may be made. At block 820, the account balance is decremented by an amount corresponding to the determined charge. The account balance may be synced with the host server whenever the client device is online.

At decision block 825, if the client device is online, a charge request may be sent to the host server at block 830. In one implementation, the charge request may include an amount of the charge, the e-book segments corresponding to the charge, user identifying information such as user ID, e-book identifier, and the like. An acknowledgement or confirmation including the new account balance information may be returned to the client application from the host server in one embodiment. Alternately, if the client device is not online, the charge request remains pending for transmission to the host server when the client device goes online. In some implementations, the user may be required to periodically connect the client device to the Internet via Wi-Fi, mobile or other connections so that accounting and other information can be synced with the host server and/or the content server.

At block 835, the e-book segment is marked as paid for or user owned since the account balance at the client side is updated. At decision block 840, if the account balance, after the updating, is below a threshold or equal to zero, a notification is generated for the user regarding the low or no account balance at block 845. Alternately, if the account balance is above a threshold or above zero, the process ends at block 850.

In an another embodiment of the ICPM system, a user can open an e-book for reading by selecting the e-book link or cover displayed by the content viewer on the client application, or in the personal download center. The content file corresponding to the selected e-book may be located and displayed by the content viewer on the screen of the client device. The viewer launches the first page or the page the user left off in the previous reading session. The user can instruct the client application to go to the next page, a certain point in the e-book, table of contents, a previously created bookmark, last page read, and the like. The client application interprets the user requests and determines the portion of the e-book that should be exposed on the display area, instructs the viewer to expose the same. The client application continually registers or recognizes the segment of e-book content exposed, and the length of time that the e-book content segment remains exposed. The client application may also monitor all activities by the user while the e-book content segment is exposed. For example, the client application can log activities such as creation of a bookmark, highlighting of text, sending or sharing portions of text or remarks to external sites, and the like. The client application can also access all available location data through the GPS on the client device or other location based services to determine the location of the user when reading the e-book segment. The client application uses the charging model downloaded with the e-book, along with additional information such as the e-book, the user, his or her reading history, the time, the location, and the like to determine the correct charge amount and charge mechanism for the specific e-book, user, time and place. The client application can use the associated charging model to determine if, when and what charges, if any, should be associated with an e-book segment displayed on the client device. For example, the charging model can charge for each percentage of the book read, a percentage of the price. The client application adds the total e-book segments exposed to the user and when the total segments exposed equals or is greater than a percentage of the e-book, a charge request can be sent to the host server to update the account balance on the server side, or the account balance can be decremented by an amount equal to the percentage of the price on the client side.

Exposure of content on the screen by the client application may not automatically lead to charging. The client application constantly monitors the e-book segments exposed by the viewer and aggregates the segments, so that at any given point in time, the client application is aware of the which specific e-book segments (e.g., line 1-200, page 1-30, 12% to 14% word count, etc.) that user has already read.

In some implementations, when the account balance is below a certain threshold, the client application can initiate certain events, such as generate an alert to the user, gradually fade the font color or change the background color, or add a water mark to slowly make the e-book content illegible, initiate automatic top-up of the balance, ask the user to increase his balance, stop the e-book content segment from being exposed to the user, and the like.

In one implementation, after a certain number of actions by the user or after a certain time interval passes, the client application can initiate or establish a connection to the host server to send all or some of the data gathered or generated by the client application to the host server. In one implementation, the host server can redo some of the calculations performed by the client application and/or perform additional calculations to determine the charges, update account balances, update user profiles, and the like.

Some embodiments of the ICPM system support e-book gifting. Using the e-book gifting mechanism, a gift is actually purchased if and only if it brings value to the receiver, and to the extent it brings value to the receiver. For example, a gift giver gives one or more e-books as a gift to a receiver. The receiver receives the e-book, and stores it. There is no exchange of money until the receiver starts consuming the e-book received as a gift. When a charge event occurs as a result of the receiver consuming a certain amount of e-book segments, the user account of the gift giver is charged an amount corresponding to the amount of e-books segments consumed by the gift receiver. To the gift receiver, there is no charge for reading the book, and no awareness that an incremental charge is created on the gift giver's user account as the reading progresses. If no reading occurs, no charge is created on the gift giver's user account.

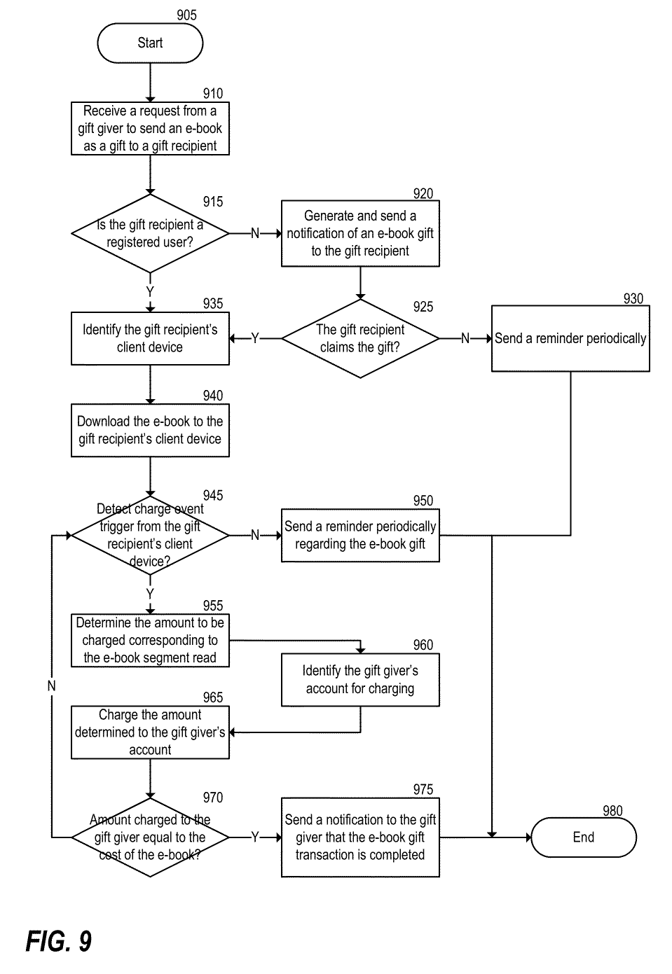

Gift giving using the ICPM system can be configured in many ways. For example, a user can give a gift of ‘reading pages’ without specifying a particular e-book or e-books. The receiver can then read any e-book or e-books he or she desires while the charge appears on the giver's account, until a certain limitation (e.g., 1000 pages, 30 days, etc.) has been reached, for example. In some implementation, a group of people can give a gift to one person, and the charge will be divided between the accounts of the group of people. In other implementations, a person or a group can give a gift to a group (e.g., 4th graders in Waco, Tex.), and the accumulated charges created by the receivers will be divided between all the givers. In some implementations, a gift may cover a portion of the reading charges (e.g. 50% off the next 1000 pages read), and the like. FIG. 9 is a logic flow diagram illustrating an exemplary method of gifting an e-book in one embodiment of the ICPM system.

The process starts at block 905. At block 910, a request from a gift giver to send an e-book as a gift to a recipient is received. The request may be initiated from the client application, for example, and may be received and processed by the host server, for example. In one implementation, the request may include an e-book identifier, recipient identifying information such as name and/or email address, requesting user or gift giver identifier, and the like. At decision block 915, the host server may determine if the gift recipient is a registered user of the ICPM system. A registered user has a user account with the ICPM system, and may have a client application installed on his or her client device. If the recipient is not a registered user, at block 920, the host server generates and sends a notification of an e-book gift to the recipient using the requesting user provided recipient information (e.g., an email). At decision block 925, the host server can detect whether the gift recipient has claimed the gift. The gift may be claimed or redeemed using an identifier provided in the notification to the recipient. Alternately, if the recipient uses the same email address or other identifying information as on record to open a user account, the host server can determine that the recipient is now a registered user.

When a non-registered recipient claims or redeems the gift by opening a user account, or when the recipient is a registered user, at block 935, the gift recipient's client device is identified. At block 940, the e-book gift is pushed to the recipient's client device. Alternately, the e-book gift may be displayed on the recipient's personalized store, and the recipient may be requested or alerted to claim or redeem the gift at no charge.

After the e-book gift is downloaded to the recipient's client device, the host server may receive a charge request or a charge event trigger from the gift recipient's client device. If such a charge request or event trigger is detected at decision block 945, the host server may parse and examine the charge request to determine the amount of the charge, e-book segments read, user account associated with the charge, and the like at block 955. At block 960, the host server identifies the gift giver's account that is to be charged. At block 965, the host server charges the amount corresponding to the e-book segments read to the gift giver's user account. At decision block 970, the host server may check if the total amount charged to the gift giver has reached the total value of the e-book. If true, the host server can send a notification to the gift giver that the e-book gift transaction is completed, concluding the process at block 980. Alternately, the host server may wait for the next charge request for further processing.

Referring back to decision block 925, if the gift recipient does not redeem the e-book gift, the host server may send a reminder periodically. Similarly, if the recipient does not consume or read the e-book, a reminder regarding the e-book gift may be sent periodically.

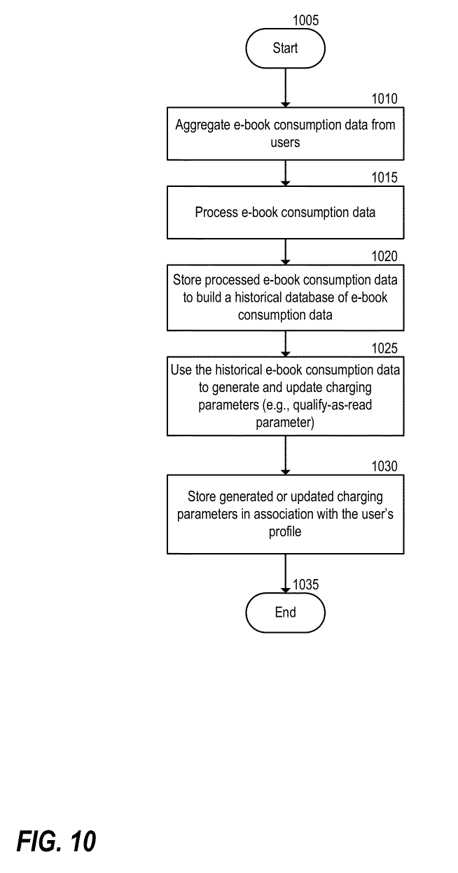

Embodiments of the ICPM system aggregate consumption related activity and event data and analyze the aggregated data to build and update user profiles, generate and/or update charging models and associated parameters, identify marketing and sales opportunities for content providers, and the like. For example, the logic flow diagram of FIG. 10 illustrates an example method of updating charging parameters in one embodiment of the ICPM system.

The process starts at block 1005. At block 1010, the host server aggregates e-book consumption data from the users of the ICPM system. At block 1015, the e-book consumption data can be processed. Example processing may include formatting or normalizing the data in preparation for storage. In one implementation, for example, some e-book consumption data needs to be normalized because the definition of a segment varies based on the formatting options selected and the display area. At block 1020, the e-book consumption data can be stored to build a historical database of e-book consumption data. At block 1025, the historical e-book consumption data can be used to update conversion parameters. For example, the historical database of e-book consumption data can be queried to select data relating to length of time spent on reading a page collected during a selected time period. An average or median of the selected data can be calculated to determine the qualify-as-read parameter for reading a page by the user. At block 1030, the generated parameter can be stored in association with the user's profile, and can be used in determining the charge for reading an e-book segment. The process ends at block 1035.

Aggregated e-book consumption data may be used to generate e-book recommendations. FIG. 11 is a logic flow diagram illustrating an exemplary method of generating recommendations in one embodiment of the ICPM system.

The process starts at block 1105. At block 1110, a list of e-books consumed by a user may be selected. For example, a query may be created and executed on the analytics database 370 to select the list of e-books consumed by a user during the last three months. At block 1120, one or more criteria for ranking the identified e-books may be selected. Example criteria can include: percent completion, reading location, e-books shared, e-books gifted, time of e-book consumption, rate of e-book consumption, bookmarks, highlights, and the like. At block 1125, the weights for each of the selected criteria may be obtained. For example, percentage completion criteria may be assigned a higher weight of 40%, reading location may be assigned 5%, e-books shared may be assigned 10%, e-books gifted 10%, time of e-book consumption 5% and rate of e-book consumption 30%.

At block 1130, a score for each e-book in the list may be calculated based on the selected criteria and criteria weight. For example, for e-book A:

Percent completion (weight of 50%)=40%

Reading location (weight 10%)=1 (matches current location)

E-book sharing (weight 10%)=1 (was shared at least once)

E-book gifted (weight 15%)=0 (was not gifted)

Time of consumption (weight 5%)=1 (matches the consumption time)

Rate of consumption (weight 10%)=2 (e.g., twice the average time taken by a group of users to read the e-book)

E-book A's score=Σweight×value of each criteria=(0.5×0.4)+(0.1×1)+(0.1×1)+(0.15×0)+(0.05×1)+(0.1×2)=0.2+0.1+0.1 +0+0.05+0.2=0.65

At block 1135, the e-books in the list are ranked based on the e-book score. At block 1140, the top x number of e-books in the list are selected, and other e-books similar to the selected x number of e-books are identified. The similar e-books may be identified based on matching of metadata and/or other attributes. At block 1145, the identified e-books are provided as recommendations to the user. Periodically, an update trigger may be generated to update the recommendation. The update trigger may be an activity relating to the e-book, such as an e-book download, sharing, gifting, adding to shelf, and the like. At decision block 1150, if such a trigger is received, the process moves back to block 1110. If no trigger is received, the process ends at block 1155.

Example User Interfaces

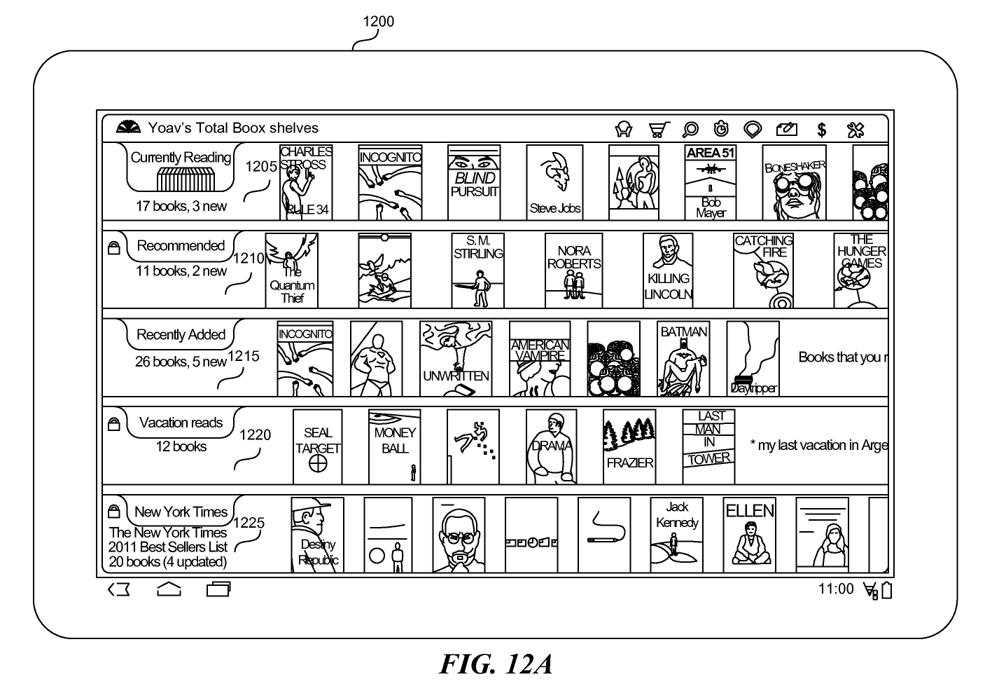

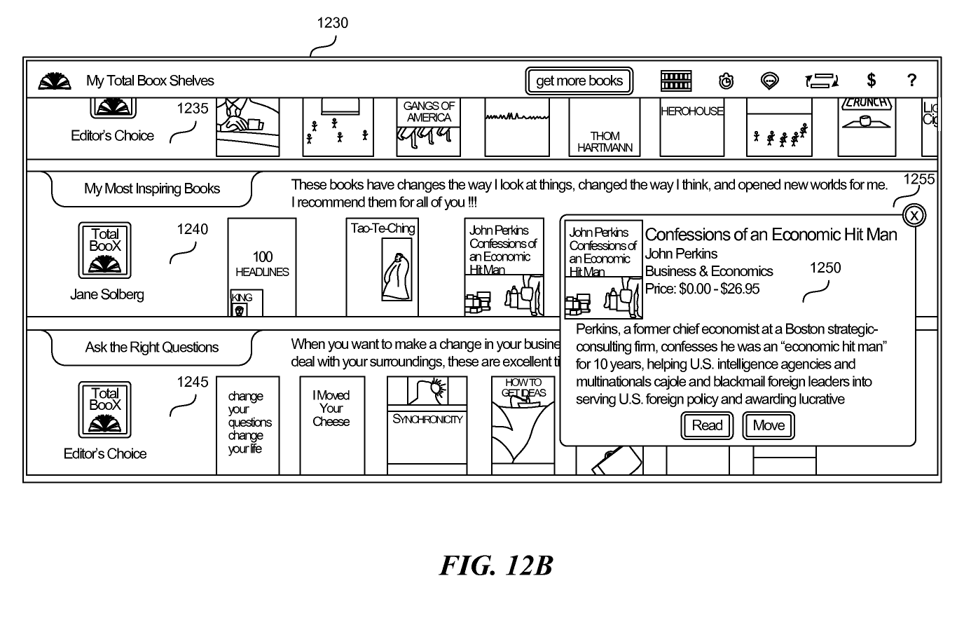

The user interface module 260 of the client application generates and/or renders various user interfaces of the client application. FIGS. 12A-B are exemplary user interface diagrams illustrating e-book shelves displayed on a client device. User interface 1200 of FIG. 12A illustrates a series of e-book shelves 1205-1225 that are downloaded or created by a user of the client device. The user interface 1200 can include options to create a shelf, give the shelf a name, and fill the shelf with e-books. Some shelves reflect the user's reading activity and may be system generated. Some shelves may be user generated. For example, the currently reading 1205, the recently added 1255, recently read shelves, and the like represent the user's activity and may be a created by the client application, the user or a combination of both. Some shelves may be filled with e-books identified by the system. For example, the recommended shelf 1210 can be filled with e-books identified by the recommendation engine 320. Some shelves (e.g., 1210, 1220, 1225) are locked and their content are final and unchangeable, while other shelves (e.g., 1205, 1215) can be modified by adding or deleting e-books, for example. Anyone having a user account may create his or her own shelf (e.g., ‘John's best sci-fi books’).

Some or all shelves can be shared with one or more users, posted on a social network site, advertised on a website, shown as part of a personal or corporate profile, and the like. The user interface 1200 may include options including search options for searching for shelves available on the ICPM system, browsing, downloading, sharing, printing, emailing, advertising, promoting, and the like, with or without being aware of the e-books the shelves may include.

Referring to user interface 1230 in FIG. 12B, three e-book shelves 1235, 1240 and 1245 are depicted. For each shelf, the creator of the shelf can add a brief description 1255. Once a shelf is downloaded, a user can select an e-book from the shelf to read a brief description of the e-book, as shown in the overlay 1250, and start reading the e-book by selecting the read option.

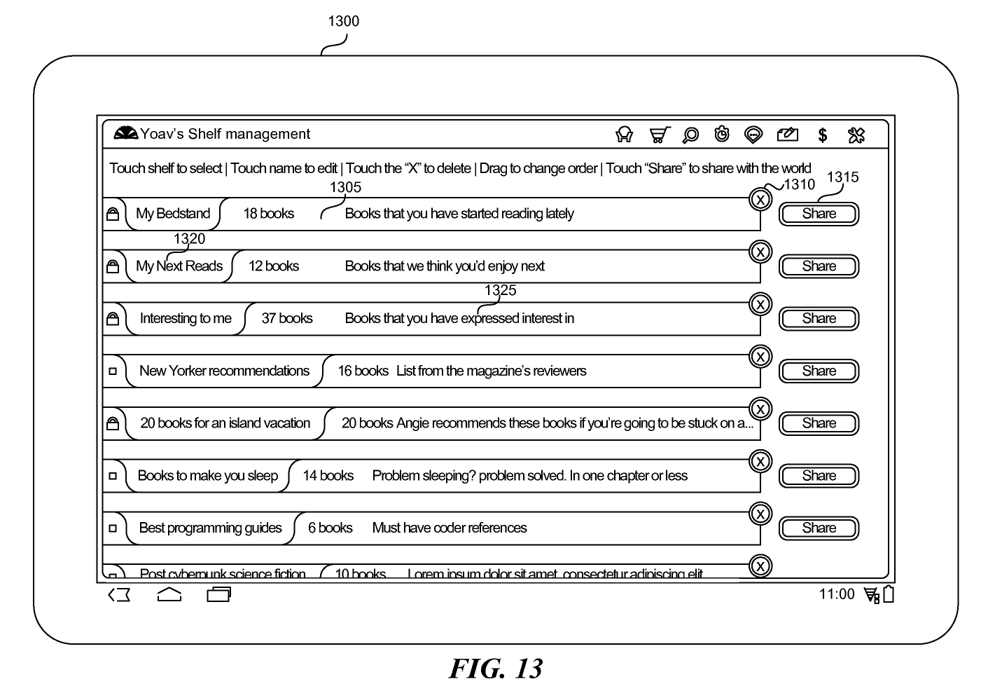

Referring to FIG. 13, example user interface 1300 depicts shelf management in shelf mode. The shelf mode provides the user an option to re-arrange any of the shelves. In the shelf mode, only the shelves may be visible with the e-books in the shelf remain hidden. The user can perform various management functions in the shelf mode. For example, the user can tap, touch, select, click, hover, etc., a shelf 1305 to select the shelf. The user can also select the shelf name area 1320 to edit the name of the shelf and over the description area 1325 to edit the description. The user can also select icon 1310 to delete the shelf. In one implementation, deleting the shelf may not delete the e-books included in the shelf. In an alternate implementation, deleting the shelf may delete the e-books in the shelf that have not been used by the user. In one implementation, the shelf may be deleted from the user's client application, but a copy may be saved in the server. The user may have to perform an additional delete (e.g., permanently delete) or confirm deletion to remove the backup from the server. The user can also select and drag a shelf to a desired location to change the order in which the shelves are displayed on the client application. In one implementation, the user interface may include an option to change the order of the e-books in the shelf by dragging each e-book icon or thumb nail, for example. The share button 1315 allows the user to share the e-book shelf using one or more channels including Facebook, Twitter, blogs, email, print, and the like. One or more of the features described herein may be accessed outside of the shelf management mode, in some implementations.

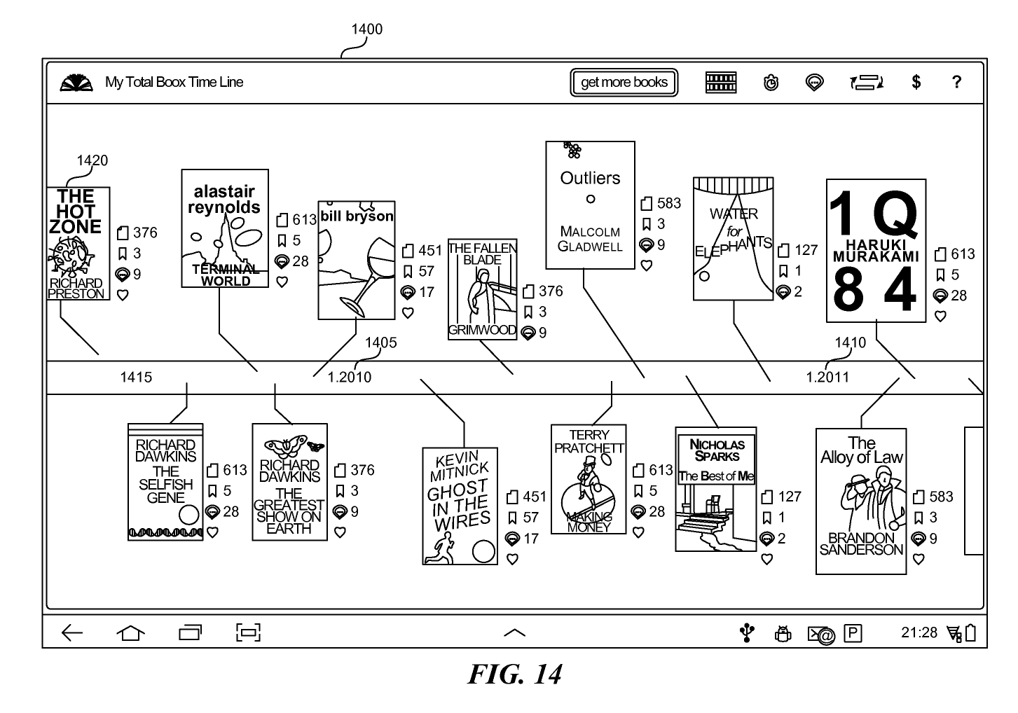

Referring to FIG. 14, user interface 1400 depicts a time line of user activity. User activities and reading history is diagrammed on a reading timeline 1415 to allow the user to get an immediate overview of the e-books consumed by the user over time. For example, the timeline 1415 depicts six e-books read by the user between January 2010 (1405) and January 2011 (1410) in the sequence in which the e-books were consumed. The user interface 1400 may also include a summary or overview of activities by number next to each e-book. For example, associated with e-book 1420 are numbers 376, 3, 9 and a symbol. The 376 may refer to the number of pages of the e-book read by the user, 3 is the number of bookmarks created by the user, 9 is the number of comments associated with the e-book, and the symbol is indicative of the e-book having been favorited by the user (i.e., marked as a favorite). Additional information such as number of shares, percent completion, location of reading, and the like or less information may also be displayed on the timeline diagram 1400.

Referring to FIG. 15, user interface 1500 depicts account management options. In one implementation, user interface 1500 displays balance 1505 in the account, and an option 1510 to add more funds to the account. User interface 1500 may also display some or all of the e-books that have been at least partially purchased. For example, table 1515 displays a list of e-book titles, author information, date the user started reading the e-book, total amount of charge associated with the e-book, and the like. More or less information can also be displayed on the table 1515. In some implementations of the user interface 1500, a snapshot 1520 of the user's reading activity may be displayed. The snapshot 1520 may include information such as the number of pages read to date, number of pages read in a single sitting or a session, number of books finished, the farthest book read, quotes highlighted, and the like. In one implementation, a map 1525 may also be displayed on the user interface 1500. The user interface aggregates location data associated with reading sessions and maps the location data, such that the user can see in the map the locations where (and in some cases when) each e-book was read.

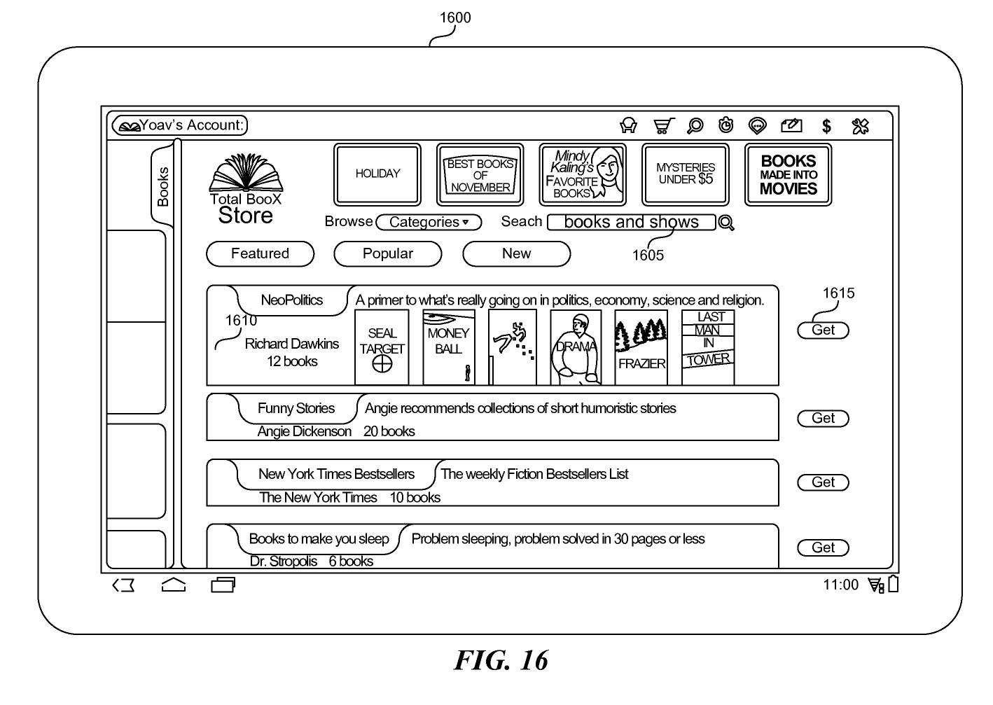

Referring to FIG. 16, user interface 1600 depicts an implementation of a personal download center. User interface 1600 displays e-books and shelves (e.g., 1610). The user interface also includes a search bar 1605 for searching e-books or shelves, and a button option 1615 to download a shelf of e-books. The user interface 1600 also includes options for browsing, accessing featured, popular or new e-books or shelves, and the like.

Referring to FIG. 17, user interface 1700 depicts an example e-book viewer. The e-book viewer displays e-book content in the display area. The e-book viewer includes tab 1705 that includes options for changing the font size, name, background color, creating bookmarks, jumping to the table of contents, jumping to a bookmarked page and the like. The e-book viewer may also display an indicator tab that continually tracks and displays, using a progress bar (e.g., 1720) and/or in text (e.g., 1725), the aggregate percentage of e-book read, regardless of the sequence.

Referring to FIG. 18, user interface 1800 depicts an example analytics dashboard. A content provider can access the analytics dashboard via a content provider client application or via the web to generate and/or view consumption data relating to e-books and users. For example, under the general tab 1820, the content provider may select a time period 1802, and an e-book 1805 to view aggregated data relating to the e-book over the defined time period. Example data relating to the e-book that can be displayed include, active readers of the e-book, total pages read by the e-book, revenue amount (e.g., in area 1810). The user interface may also display a bar chart 1815 showing the number of users who have downloaded the e-book, who have started the e-book and who have completed the e-book during each month over the selected time period. The content provider can also edit the description of the e-book, change the retail price of the e-book, modify any parameters that affect the charging model of the e-book, and the like directly from the user interface 1800.

Under the reader tab 1825, data relating to the readership of the selected e-book may be displayed. For example, graphical charts relating to the distribution of users based on gender, age, time of reading (day reader versus night readers), day of reading (e.g., weekday readers versus weekend readers), and the like may be displayed.

Under the activity tab 1830, data relating to the user activities may be displayed. For example, chart 1835 displays the total activity mark of the selected e-book compared to that of the average activity mark for the non-fiction genre. In one implementation, the activity mark may be a weighted score of one or more activities such as download, read, share, gift, Tweet or Facebook, quote, and the like associated with an e-book. Chart 1840 displays the number of times the e-book was sent each month during the selected time period. Chart 1845 displays the number of times the e-book was gifted each month during the selected time period. Chart 1850 displays the number of time the e-book was tweeted or shared via Facebook or other social network sites each month during the selected time period. Similarly, the quotes chart 1855 displays the number of times quotes from the e-book was selected per month the during the selected time period. The quotes shared chart 1860 displays the number of times quotes from the e-book was shared per month the during the selected time period. More or less activity data may be charted and displayed to the content provider.

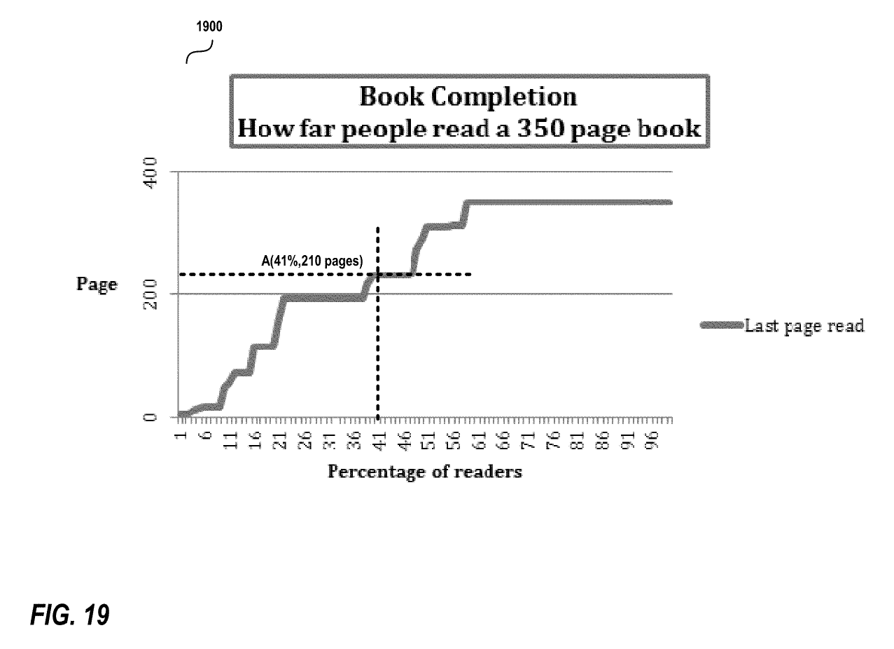

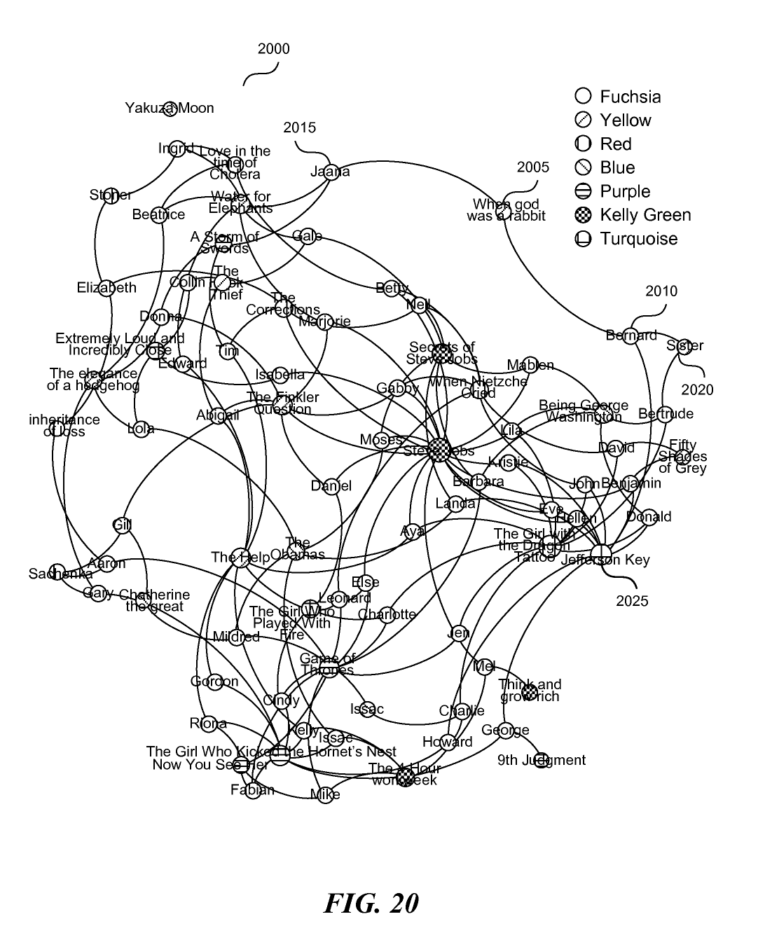

Referring to FIG. 19, an example chart 1900 is depicted. The chart plots the number of pages read against percentage of readers, and shows the completion pattern of an e-book at a given time. Based on the graphical data, it can be determined that at least 41% of the readers have read at least 210 pages of the e-book. Referring to FIG. 20, an example relational map 2000 is depicted. The relational map 2000 maps the relationship between readers and e-books read by the readers. In the relational map 2000, e-book 2005 was read by two readers 2015 and 2010. Reader 2010, who read e-book 2005, also read e-books 2020 and 2025, and so on. Furthermore, in some implementations, the size and color of the circles representing e-books may be varied to reflect additional attributes such as the number of readers, genre and the like. For example, the size of the circle 2005 is smaller than the size of the circle 2025 to reflect that e-book 2025 has more readers than e-book 2005.

Example Computer Systemization

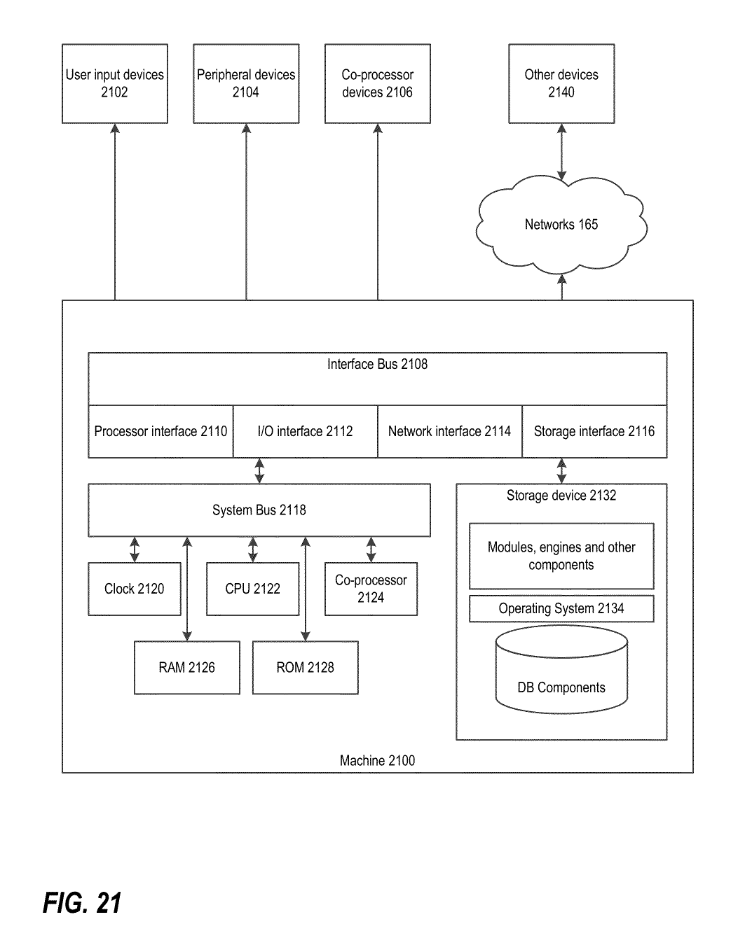

Aspects and implementations of the ICPM system have been described in the general context of computer-executable instructions, such as routines, modules, engines or components executed by a general-purpose computer, a personal computer, a server, and/or other computing systems. A representation of a machine in the example form of a computer system such as the host server 125, the content server 110, personal download center 105 and the client device 145 is illustrated in FIG. 21. The machine 2100 may be in communication with entities including one or more users (e.g., ICPM users 140, affiliate users 155, content providers 115) or other devices 2140. The other devices can be client devices when the machine 2100 is the host server 125 or the host server 125, the content server 110 or the personal download center 105 when the machine 2100 is the client device 145. The machine 2100 may also be in communication with user input devices 2102, peripheral devices 2104, an optional co-processor device(s) (e.g., cryptographic processor devices) 2106, and networks 165. Users 140 may engage with the host server 125 via client devices 145 over networks 165.

Computers employ central processing unit (CPU) or processor (hereinafter “processor”) to process information. Processors may include programmable general-purpose or special-purpose microprocessors, programmable controllers, application-specific integrated circuits (ASICs), programmable logic devices (PLDs), embedded components, combination of such devices and the like. Processors execute program components such as in response to user and/or system-generated requests. One or more of these components may be implemented in software, hardware or both hardware and software. Processors pass instructions (e.g., operational and data instructions) to enable various operations.

The machine 2100 may include clock 2120, CPU 2122, memory such as read only memory (ROM) 2128 and random access memory (RAM) 2126 and co-processor 2124 among others. These controller components may be connected to a system bus 2118, and through the system bus 2118 to an interface bus 2108. Further, user input devices 2102, peripheral devices 2104, co-processor devices 2106, and the like, may be connected through the interface bus 2108 to the system bus 2118. The Interface bus 2108 may be connected to a number of interface adapters such as processor interface 2110, input output interfaces (I/O) 2112, network interfaces 2114, storage interfaces 2116, and the like.

Processor interface 1010 may facilitate communication between co-processor devices 2106 and co-processor 2124. In one implementation, processor interface 2110 may expedite encryption and decryption of requests or data. Input Output interfaces (I/O) 2112 facilitate communication between user input devices 2102, peripheral devices 2104, co-processor devices 2106, and/or the like and components of the machine 2100 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 2114 may be in communication with the network. Through the network, the machine 2100 may be accessible to remote client devices 145 or server computers. Network interfaces 2114 may use various wired and wireless connection protocols such as, direct connect, Ethernet, wireless connection such as IEEE 802.11a-x, and the like. Examples of network 165 include the Internet, Local Area Network (LAN), Metropolitan Area Network (MAN), a Wide Area Network (WAN), wireless network (e.g., using Wireless Application Protocol WAP), a secured custom connection, and the like. The network interfaces 2114 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand. Other network security functions performed or included in the functions of the firewall, can be, for example, but are not limited to, intrusion-prevention, intrusion detection, next-generation firewall, personal firewall, etc., without deviating from the novel art of this disclosure.

Storage interfaces 2116 may be in communication with a number of storage devices such as, storage devices 2132, removable disc devices, and the like. The storage interfaces 2116 may use various connection protocols such as Serial Advanced Technology Attachment (SATA), IEEE 1394, Ethernet, Universal Serial Bus (USB), and the like.

User input devices 2102 and peripheral devices 2104 may be connected to I/O interface 2112 and potentially other interfaces, buses and/or components. User input devices 2102 may include card readers, finger print readers, joysticks, keyboards, microphones, mouse, remote controls, retina readers, touch screens, sensors, and/or the like. Peripheral devices 2104 may include antenna, audio devices (e.g., microphone, speakers, etc.), cameras, external processors, communication devices, radio frequency identifiers (RFIDs), scanners, printers, storage devices, transceivers, and/or the like. Co-processor devices 2106 may be connected to the machine 2100 through interface bus 2108, and may include microcontrollers, processors, interfaces or other devices.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. The machine 2100 may employ various forms of memory including on-chip CPU memory (e.g., registers), RAM 2126, ROM 2128, and storage devices 2132. Storage devices 2132 may employ any number of tangible, non-transitory storage devices or systems such as fixed or removable magnetic disk drive, an optical drive, solid state memory devices and other processor-readable storage media. Computer-executable instructions stored in the memory may include the ICPM system 200 or the ICPM system 300 having one or more program modules such as routines, programs, objects, components, data structures, and so on that perform particular tasks or implement particular abstract data types. For example, the memory may contain operating system (OS) component 2134, program modules and other components (e.g., components 205-270 of ICPM system 200, components 305-348 of ICPM system 300), database tables (e.g., 360-382 of ICPM system 300) and the like. These modules/components may be stored and accessed from the storage devices, including from external storage devices accessible through an interface bus.

The database components are stored programs executed by the processor to process the stored data. The database components may be implemented in the form of a database that is relational, scalable and secure. Examples of such database include DB2, MySQL, Oracle, Sybase, and the like. Alternatively, the database may be implemented using various standard data-structures, such as an array, hash, list, struct, structured text file (e.g., XML), table, and/or the like. Such data-structures may be stored in memory and/or in structured files.

The machine 2100 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the machine 2100 may be distributed electronically over the Internet or over other networks (including wireless networks). Those skilled in the relevant art will recognize that portions of the machine 2100 may reside on a server computer, while corresponding portions reside on a client computer. Data structures and transmission of data particular to aspects of the machine 2100 are also encompassed within the scope of the invention.

Conclusion

The above Detailed Description of embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I claim:

1. A processor-implemented method, comprising:
monitoring, on a client device, user interaction with one or more electronic book segments of an electronic book;
determining, by a processor, whether the user interaction with the one or more electronic book segments is a chargeable interaction; and
creating a charge against a user account for the chargeable interaction with the one or more electronic book segments.

2. The method of claim 1, wherein the charge against the user account is created when the one or more electronic book segments associated with a chargeable interaction is at least a predetermined portion of the electronic book.

3. The method of claim 1, wherein the electronic book is divisible into a plurality of electronic book segments, each segment having an amount of content that is determined by the client device and a user of the client device.

4. The method of claim 1, wherein the user interaction is determined to be a chargeable interaction based on a length of user interaction with each of the one or more electronic book segments.

5. The method of claim 4, wherein the length of the user interaction is a parameter derived from historical user interaction data.

6. The method of claim 1, wherein each of the one or more electronic book segments corresponds to a portion of the electronic book that is on display on the client device.

7. The method of claim 1, wherein the one or more electronic book segments is a part of a chapter of the electronic book, and wherein the charge against the user account is created when the user interaction with the chapter is completed.

8. The method of claim 1, wherein a user associated with the user interaction and the client device is different from a user associated with the user account against which the charge is created.

9. The method of claim 1, wherein a user associated with the user interaction is also associated with the user account against which the charge is created.

10. The method of claim 1, wherein no charge against the user account is created for the user interaction with one or more electronic book segments that is not a chargeable interaction.

11. The method of claim 1, wherein creating a charge against the user account for the chargeable interaction with the one or more electronic book segments includes:
calculating an amount corresponding to the charge based on a charge model associated with the electronic book and the one or more electronic book segments; and
decrementing a balance on the user account by the calculated amount.

12. The method of claim 11, further comprising:
determining whether the chargeable interaction qualifies for a discount;
if so, determining a discount amount; and
adjusting the calculated amount based on the discount amount prior to decrementing the balance on the user account.

13. The method of claim 12, wherein the chargeable interaction qualifies for a discount when a geographical location of the chargeable interaction matches a predetermined geographical location.

14. The method of claim 1, further comprising:
determining whether a network connection is available between the client device and a remote server;
if so, sending a charge request to the remote server to charge the user account a purchase price associated with the one or more electronic book segments for which the user interaction is a chargeable interaction.

15. The method of claim 1, further comprising:
designating the one or more electronic book segments as purchased segments when the user account is charged a purchase price associated with the one or more electronic book segments, wherein the purchased electronic book segments are available for interaction with a user of the client device without incurring an additional charge.

16. The method of claim 1, further comprising:
determining that the user interaction with the one or more electronic book segments meets at least one condition; and
dynamically adjusting a purchase price associated with the one or more electronic book segments, wherein the charge corresponds to the adjusted purchase price of the one or more electronic book segments.

17. The method of claim 16, wherein the at least one condition specifies that the one or more electronic book segments include content from a predefined portion of the electronic book.

18. The method of claim 1, further comprising:
downloading, from a remote server, the electronic book to the client device at no cost.

19. The method of claim 1, wherein the electronic book is available for user interaction regardless of whether the client device is online or offline.

20. The method of claim 1, wherein the one or more electronic book segments are not sequentially arranged in the electronic book.

21. The method of claim 1, further comprising:
sending a user request to share an electronic book stored locally on the client device with one or more users, wherein in response to the user request, the electronic book is downloaded to client devices of the one or more users free of charge.

22. The method of claim 1, further comprising:
monitoring balance on the user account to determine whether to allow or block user interaction with the one or more electronic book segments.

23. A system, comprising:
a memory;
a processor disposed in communication with the memory, and configured to process a plurality of instructions to:
monitor user interaction with one or more electronic book segments of an electronic book;
determine whether the user interaction with the one or more electronic book segments is a chargeable interaction; and
create a charge against a user account for the chargeable interaction with the one or more electronic book segments.

24. A processor-readable non-transitory medium storing instructions to:
monitor user interaction with one or more electronic book segments of an electronic book;
determine whether the user interaction with the one or more electronic book segments is a chargeable interaction; and
create a charge against a user account for the chargeable interaction with the one or more electronic book segments.

25. A processor-implemented method, comprising:
receiving a user request to download at least one electronic book to a client device;
determining, via a processor, whether the at least one electronic book is associated with a charging model that defines charging parameters, wherein the charging parameters include at least one micropayment amount to be charged to at least one user account and an electronic book portion corresponding to the at least one micropayment amount; and
downloading the at least one electronic book and the charging model parameters to the client device in response to the user request.

26. The method of claim 25, wherein the at least one electronic book is downloaded at no cost to a user of the client device.

27. The method of claim 25, wherein the at least one electronic book is downloaded at an upfront cost that is a fraction of the total cost of the electronic book, with the remaining amount of the total cost of the electronic book being charged to the at least one user account based on monitoring of the consumption of the at least one electronic book.

28. The method of claim 25, further comprising associating a promotional offer with one or more electronic book consumption attributes.

29. The method of claim 28, wherein the one or more electronic book consumption attributes is specific to the at least one electronic book.

30. The method of claim 29, wherein the one or more electronic book consumption attributes include geographical location of a user of the client device, time of electronic book consumption or length of an electronic book consumption session.

31. The method of claim 25, wherein the charging model defines charging parameters based on at least one of: a charge event, type of electronic book segment, size and type of electronic book, location of content within an electronic book, time, price, previously consumed electronic books or geographical location of a user of a client device.

32. The method of claim 25, further comprising:
identifying one or more electronic books associated with a user;
selecting based on at least one of reading related and non-reading related criteria for ranking the one or more electronic books;
scoring each of the one or more electronic books based on the selected criteria; and
generating recommended electronic books based on the scoring.

33. The method of claim 25, further comprising associating a payment model with the at least one user account, wherein the payment model is one of a subscription based payment model or a pay per electronic book segment consumption model.

34. A processor-implemented method, comprising:
downloading an electronic book for conditional purchase;
dividing the electronic book into a plurality of electronic book segments, wherein the size of each electronic book segment is defined at the time of consumption;
identifying each electronic book segment at the time of consumption;
detecting consumption of one or more electronic book segments from the plurality of electronic book segments;
detecting a charge event associated with the electronic book;
determining a charge amount corresponding to the one or more electronic book segments consumed in response to the charge event; and
charging a user account the determined charge amount.

35. The method of claim 34, further comprising transferring ownership of the one or more electronic book segments to a user associated with the user account.

36. The method of claim 34, further comprising:
aggregating reading activity and non-reading activity data relating to the electronic book for transmission to a remote server.

37. The method of claim 36, wherein the reading activity and non-reading activity data relating to the electronic book is used to generate statistical indicators for the electronic book.

38. The method of claim 34, wherein the charge event is generated when the one or more electronic book segments consumed at least equal a predefined size.

39. The method of claim 34, wherein the predefined size is one of: a number of pages of the electronic book, a percentage of the electronic book or a number of lines of the electronic book.

40. The method of claim 34, wherein the charge amount corresponding to the one or more electronic book segments consumed is determined using a charge model defined for a user associated with the consumption and the electronic book.
